(19) United States
(12) Patent Application Publication
(10) Pub. No.: US 2025/0314991 A1
(43) Pub. Date: Oct. 9, 2025

(54) IMAGE FORMING APPARATUS

(71) Applicant: CANON KABUSHIKI KAISHA, Tokyo (JP)

(72) Inventor: Hidehiro Wakamiya, Chiba (JP)

(21) Appl. No.: 19/170,260

(22) Filed: Apr. 4, 2025

(30) Foreign Application Priority Data
Apr. 8, 2024 (JP) 2024-062299

(51) Int. Cl. G03G 15/08; G03G 15/01

(52) U.S. Cl. CPC G03G 15/0863; G03G 15/0121; G03G 15/0865; G03G 2215/0177

(57) ABSTRACT

An image forming apparatus has a rotary supporting the first and second cartridges each displaced between two positions, and a detector connected to a circuit including a third contact portion. After the first cartridge has started to move from the first position to the second position, a first contact portion in the first cartridge comes into contact with the third contact portion. When the first contact portion has come into contact with the third contact portion, the detector detects a signal generated in the circuit. After the second cartridge has started to move from the first position to the second position, a second contact portion in the second cartridge comes into contact with the third contact portion. When the second contact portion has come into contact with the third contact portion, the detector detects a signal generated in the circuit.

### BACKGROUND OF THE INVENTION

### Field of the Invention

The present invention relates to an image forming apparatus.

### Description of the Related Art

In some color image forming apparatuses, exchangeable developer containers containing developers, such as toner, are separate from developing devices (see, for example, Japanese Patent Laid-Open No. 2012-61706).

Regarding the configuration of the foregoing background, in a case where a developer container of a wrong color is attached to a developing device, a developer of a wrong color is supplied to the developing device.

### SUMMARY OF THE INVENTION

In view of the above, the present invention prevents a wrong developer container from being attached to a developing device.

An aspect of the present invention provides an image forming apparatus to/from which a first cartridge and a second cartridge are attachable/detachable, the first cartridge storing a first developer, and the second cartridge storing a second developer, the image forming apparatus comprising: a rotary including a first developing chamber configured to store the first developer supplied from the first cartridge, and a second developing chamber configured to store the second developer supplied from the second cartridge; a first tray by which the first cartridge is attachably/detachably supported, and which is displaced, relative to the rotary, between a first position where the first cartridge is located outside the rotary and a second position where the first cartridge is located inside the rotary; a second tray by which the second cartridge is attachably/detachably supported, and which is displaced, relative to the rotary, between a third position where the second cartridge is located outside the rotary and a fourth position where the first cartridge is located inside the rotary; and a detector connected to a circuit including a third contact portion, wherein after the first cartridge supported by the first tray has started to move from the first position to the second position, a first contact portion included in the first cartridge comes into contact with the third contact portion, in a case where the first contact portion has come into contact with the third contact portion, a first current is generated in the circuit, and the detector detects a signal that is based on the first current, after the second cartridge supported by the first tray has started to move from the first position to the second position, a second contact portion included in the second cartridge comes into contact with the third contact portion, and in a case where the second contact portion has come into contact with the third contact portion, a second current is generated in the circuit, and the detector detects a signal that is based on the second current.

The present invention can prevent a developer container from being placed at a wrong attachment position while suppressing an increase in the cost of the developer container.

Further features of the present invention will become apparent from the following description of exemplary embodiments with reference to the attached drawings.

### BRIEF DESCRIPTION OF THE DRAWINGS

FIG. 1 is a schematic cross-sectional diagram of an image forming apparatus according to an embodiment.

FIG. 2 is a conceptual diagram showing a configuration for supplying toner from a toner cartridge to a developing unit provided in the image forming apparatus.

FIG. 3A is a cross-sectional diagram of a rotary and the surroundings thereof provided in the image forming apparatus.

FIG. 3B is a cross-sectional diagram of the rotary and the surroundings thereof provided in the image forming apparatus.

FIG. 4 is an external view of the rotary provided in the image forming apparatus.

FIG. 5A is an external view of the image forming apparatus.

FIG. 5B is an external view of the image forming apparatus.

FIG. 5C is an external view of the image forming apparatus.

FIG. 6 is a cross-sectional diagram of the rotary and the surroundings thereof provided in the image forming apparatus (at the time of exchange of a toner cartridge).

FIG. 7A is a configuration diagram of a contact between a toner cartridge and an image forming apparatus 1 according to a first embodiment.

FIG. 7B is a configuration diagram of a contact between a toner cartridge and the image forming apparatus 1 according to the first embodiment.

FIG. 7C is a configuration diagram of a contact between a toner cartridge and the image forming apparatus 1 according to the first embodiment.

FIG. 8A is a diagram showing a transition of a contact between a toner cartridge and the image forming apparatus 1 according to the first embodiment.

FIG. 8B is a diagram showing a transition of a contact between a toner cartridge and the image forming apparatus 1 according to the first embodiment.

FIG. 8C is a diagram showing a transition of a contact between a toner cartridge and the image forming apparatus 1 according to the first embodiment.

FIG. 9A is a cross-sectional diagram showing a state of a tray inside the rotary at the time of insertion of a toner cartridge according to the first embodiment.

FIG. 9B is a cross-sectional diagram showing a state of a tray inside the rotary at the time of insertion of a toner cartridge according to the first embodiment.

FIG. 9C is a cross-sectional diagram showing a state of a tray inside the rotary at the time of insertion of a toner cartridge according to the first embodiment.

FIG. 10 is a diagram showing voltage values of an A/D port according to the first embodiment.

FIG. 11A is a flowchart showing the first embodiment.

FIG. 11B is (a continuation of) the flowchart showing the first embodiment.

FIG. 12 is a configuration diagram of a contact between a toner cartridge and the image forming apparatus according to a second embodiment.

FIG. 13A is a configuration diagram showing contact sites of a toner cartridge according to the second embodiment.

FIG. 13B is a configuration diagram showing contact sites of a toner cartridge according to the second embodiment.

FIG. 13C is a configuration diagram showing contact sites of a toner cartridge according to the second embodiment.

FIG. 13D is a configuration diagram showing contact sites of a toner cartridge according to the second embodiment.

FIG. 14 is a configuration diagram showing the shapes of leaf springs inside the image forming apparatus according to the second embodiment.

FIG. 15A is a bird's-eye view showing a state of a contact according to the second embodiment.

FIG. 15B is a bird's-eye view showing a state of a contact according to the second embodiment.

FIG. 15C is a bird's-eye view showing a state of a contact according to the second embodiment.

FIG. 16 is a diagram showing a state of an I/O port according to the second embodiment.

FIG. 17A is a flowchart showing the second embodiment.

FIG. 17B is (a continuation of) the flowchart showing the second embodiment.

FIG. 18A1 is a configuration diagram of a contact between a toner cartridge and the image forming apparatus according to a third embodiment.

FIG. 18A2 is a configuration diagram of a contact between a toner cartridge and the image forming apparatus according to the third embodiment.

FIG. 18B1 is a configuration diagram of a contact between a toner cartridge and the image forming apparatus according to the third embodiment.

FIG. 18B2 is a configuration diagram of a contact between a toner cartridge and the image forming apparatus according to the third embodiment.

FIG. 18B3 is a configuration diagram of a contact between a toner cartridge and the image forming apparatus according to the third embodiment.

FIG. 18B4 is a configuration diagram of a contact between a toner cartridge and the image forming apparatus according to the third embodiment.

FIG. 19A is a bird's-eye view showing a state of a contact according to the third embodiment.

FIG. 19B is a bird's-eye view showing a state of a contact according to the third embodiment.

FIG. 19C is a bird's-eye view showing a state of a contact according to the third embodiment.

FIG. 20 is a state diagram showing a state of a switch according to the third embodiment.

FIG. 21A is a flowchart showing the third embodiment.

FIG. 21B is (a continuation of) the flowchart showing the third embodiment.

FIG. 22 is a perspective view showing the arrangement of trays inside the rotary.

FIG. 23 is a cross-sectional diagram showing the arrangement of trays inside the rotary.

FIG. 24A is a perspective view showing a driving configuration for insertion/extraction of a tray.

FIG. 24B is a perspective view showing the driving configuration for insertion/extraction of a tray.

FIG. 25A is a cross-sectional diagram showing the driving configuration for insertion/extraction of a tray.

FIG. 25B is a cross-sectional diagram showing the driving configuration for insertion/extraction of a tray.

FIG. 26 is a perspective view showing an exemplary configuration of a contact between the image forming apparatus body and a toner cartridge.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

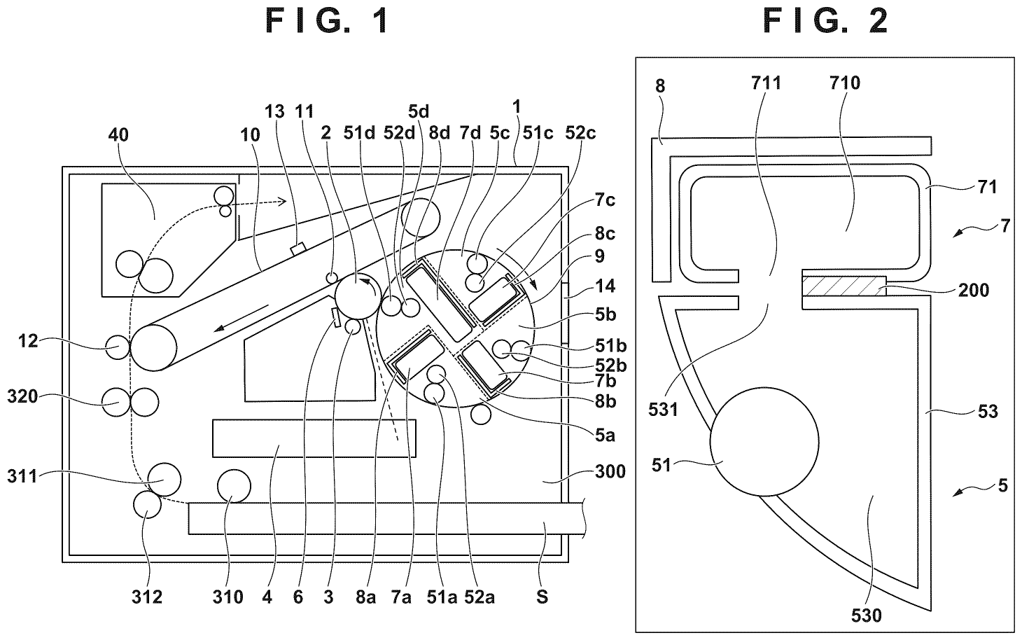

Using FIGS. 1 to 11B, an embodiment of an image forming apparatus pertaining to the present invention will be described.

### Overall Configuration of Image Forming Apparatus

An image forming apparatus pertaining to the present embodiment will be described. Below, a color laser beam printer including four developing units is exemplarily presented as an image forming apparatus including a plurality of developing units.

Using FIG. 1 and FIG. 2, a schematic configuration and an image forming operation of the color laser beam printer will be described. FIG. 1 is a schematic cross-section of the color laser beam printer.

As shown in FIG. 1, an image forming apparatus body 1 includes a drum-shaped electrophotographic photosensitive member 2 (hereinafter referred to as a photosensitive drum 2). A charging roller 3, an exposure device 4, four developing units 5a to 5d, and a cleaning unit 6 are disposed around the photosensitive drum 2. The charging roller 3 is charging means for uniformly charging the photosensitive drum 2. The exposure device 4 is exposure means for irradiating the photosensitive drum 2 with laser light corresponding to image information. As a result of irradiating the charged photosensitive drum 2 with laser light, electrostatic latent images are formed on the photosensitive drum 2. The developing units 5a to 5d are developing means for visualizing the electrostatic latent images formed on the photosensitive drum 2 by developing them using toner of corresponding colors. The cleaning unit 6 is cleaning means for removing toner remaining on the surface of the photosensitive drum 2.

The developing units 5a to 5d, which are developing parts, include developing rollers 51a to 51d, respectively. Also, toner cartridges 7a to 7d acting as developer containers storing developers (or color agents) of respective color components, which are toner in the present example, are attached to the developing units 5a to 5d. The toner cartridges 7a to 7d store yellow toner, magenta toner, cyan toner, and black toner, respectively. That is to say, the developing units 5a to 5d develop the electrostatic latent images formed on the photosensitive drum 2 using the yellow toner, the magenta toner, the cyan toner, and the black toner, respectively. Each of the toner cartridges 7a to 7d is a consumable material that is exchanged when the toner stored therein has been depleted. Here, the four developing units 5a to 5d are provided in a rotary 9 that is a rotatable or turn-style support member, that is to say, a rotary support member. Also, the rotary 9 includes trays 8a to 8d, and the toner cartridges 7a to 7d are attachably/detachably held by the trays 8a to 8d. The trays 8a to 8d are supported so that they can be slidably moved to the outside of the rotary 9, as will be described later. That is to say, it can be said that the rotary 9 is a storage for the trays 8a to 8d. As shown in FIG. 1, the toner cartridges 7a to 7d held by the trays 8a to 8d are configured to be attachable to and detachable from the rotary 9 as a result of slidably moving the trays 8a to 8d to the outside of the rotary 9 with use of a driving source M2 (not shown) and a drive transmission mechanism. When the trays 8a to 8d have been brought to the outside of the image forming apparatus body 1 through an opening of a door 14, the toner cartridges can be exchanged by an operator at that location.

Note that the trays 8 are associated with toner cartridges to be attached thereto in accordance with corresponding toner colors, respectively. In view of this, the colors of toner stored in the toner cartridges may be referred to as the colors (or color components) of the toner cartridges, and the colors of the toner cartridges that are respectively attached to the trays may be referred to as the colors (or color components) of the trays. Also, distinction may be made by referring to a developer of a specific color as a first developer or a second developer, for example. Furthermore, distinction may be made by referring to a toner cartridge storing the first developer as a first cartridge, and referring to a toner cartridge storing the second developer as a second cartridge, for example.

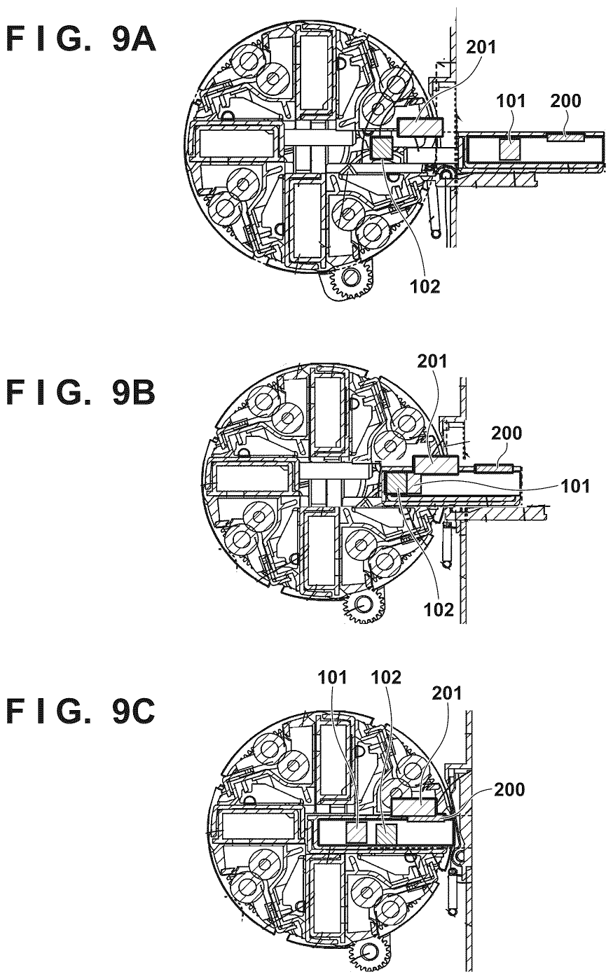

FIG. 2 is a conceptual diagram showing a configuration for supplying toner from a toner cartridge 7 to a developing unit 5. In FIG. 2, in order to show a configuration related to one toner cartridge regardless of color, signs a to d indicating the respective colors are omitted, even with respect to parts that are provided on a per-color basis. The same goes for descriptions other than FIG. 2. A toner frame body 71 of the toner cartridge 7 held by the tray 8 includes a toner storage unit 710 and a discharge opening 711 that communicates with the toner storage unit 710. Also, the toner cartridge 7 includes a toner supply valve 200 for inserting the toner into a developing frame body 53. This toner supply valve 200 connects to (or engages with) a toner supply valve opening/closing unit 201, which will be described later, in a state where the toner cartridge 7 is attached to the tray 8. Note that although the toner supply valve opening/closing unit 201 is not shown in FIG. 2, it is shown in FIG. 9A to FIG. 9C. By causing this toner supply valve opening/closing unit 201 to operate, the openable/closable toner supply valve can be opened or closed. In a case where the toner is to be supplied, this toner supply valve 200 is opened by causing the toner supply valve opening/closing unit 201 to operate. Note that in the present embodiment, as the toner supply valve is opened by the toner supply valve opening/closing unit, the toner supply valve opening/closing unit may also be referred to as a valve opening unit.

Furthermore, the developing frame body 53 of the developing unit 5 includes a developing-side storage unit 530 (also referred to as a developing chamber 530) and a receiving opening 531 that communicates with the developing-side storage unit. As will be described later, the discharge opening 711 opposes the receiving opening 531 in a state where the toner cartridge 7 has moved to an attachment position. When the toner is supplied from the toner cartridge 7 to the developing unit 5, the toner supply valve 200 is opened, and at least a part of the receiving opening 531 is positioned underneath at least a part of the discharge opening 711. Then, the toner stored in the toner storage unit 710 is discharged from the discharge opening 711, and the toner discharged from the discharge opening 711 enters the developing-side storage unit 530 through the receiving opening 531. On the other hand, when the toner supply valve 200 is closed, the toner stored in the toner storage unit 710 does not enter the developing-side storage unit 530.

### Toner Supply Valve 200 and Toner Supply Valve Opening/Closing Unit 201

Examples of configurations of the toner supply valve 200 and the toner supply valve opening/closing unit 201 will be described. The toner supply valve opening/closing unit 201 opens the toner supply valve 200 with use of an electrical driving source. The driving source may be, for example, a motor, a linear motor, a solenoid, or the like. The toner supply valve 200 is a slidable lid that slides along a case of the toner cartridge 7. The toner supply valve 200 maintains a closed state unless it is opened by the toner supply valve opening/closing unit 201, and maintains an opened state once it has been opened.

For example, the toner supply valve 200 includes a projection facing the external side of the toner cartridge 7. When the toner cartridge 7 has been attached to the tray 8, an engaging portion of the toner supply valve opening/closing unit 201 is located at a distance from the projection of the toner supply valve 200 in the closed state in such a manner that the engaging portion is substantially in contact with the projection. When the toner supply valve opening/closing unit 201 is driven in an opening direction, this engaging portion pushes the projection of the toner supply valve 200 in the closed state in the opening direction; as a result, the toner supply valve 200 is opened. While the toner cartridge 7 is in use for image formation, the toner supply valve 200 is maintained in the opened state. During the exchange of the toner cartridge 7, too, arranging the toner supply valve 200 so that it faces the upper side of the toner cartridge 7 prevents the toner from getting scattered to the outside of the toner cartridge during the exchange. In this case, it is sufficient that a worker who performs an exchange task performs the exchange after closing the toner supply valve 200.

It goes without saying that the foregoing configuration is merely an example, and it is permissible to adopt other configurations for opening/closing the toner supply valve 200 with use of the toner supply valve opening/closing unit 201. For example, an elastic body, such as a spring, may apply a force to the toner supply valve 200 in the closed state. This configuration can keep the toner supply valve 200 in the closed state as long as it is not opened by the toner supply valve opening/closing unit 201. In this configuration, for example, if the toner supply valve 200 is pushed in the opening direction, the toner supply valve 200 is locked in the opened state; in this state, if the toner supply valve 200 is pushed in the opening direction again, the lock is cancelled, and the toner supply valve 200, to which a force has been applied by the spring, becomes closed.

Note that the toner supply valve opening/closing unit 201 may be provided on a per-tray basis, or only one toner supply valve opening/closing unit 201 may be provided so as to be used in common by the toner cartridges of the respective colors. In a case where it is provided on a per-tray basis, for example, it may be provided at a position where it can drive an engaging portion of the toner supply valve 200 when the toner cartridge 7 has been attached to the tray 8 and stored in the rotary 9, such as immediately above the toner cartridge 7. In this case, later-described electrodes (contacts) and the like may also be provided on a per-tray basis. Furthermore, necessary electrical wires may be guided to the outside of the rotary 9 via a shaft of the rotary 9, and also via, for example, electrodes that slide along with rotation of the rotary 9. The guided wires are input to a later-described control unit.

On the other hand, in a case where the toner supply valve opening/closing unit 201 is provided to be shared by the toner cartridges of the respective colors, the toner supply valves 200 of the toner cartridges 7 of the respective color components are opened/closed by this single toner supply valve opening/closing unit 201. For this reason, the toner supply valve opening/closing unit 201 is provided at a position independent of rotation of the rotary 9. For example, it may be placed so as to be capable of moving the toner supply valve 200 through an end surface of the toner cartridge 7 to be exchange when the rotary 9 is at an exchange position. This position may be, for example, an end surface of the toner cartridge 7, that is to say, an end surface of the rotary 9. For this reason, an end surface of the rotary 9 may include, for example, cutouts for exposing later-described electrodes provided in the toner cartridge 7, and for driving a protruding portion for opening/closing the toner supply valve 200 via the toner supply valve opening/closing unit 201. The cutout for exposing the electrodes to the outside of the rotary 9, and the cutout for exposing the protruding portion of the toner supply valve 200 to the outside of the rotary 9, may be provided on different end surfaces of the rotary 9. Furthermore, the toner supply valve opening/closing unit 201 may be provided at end surfaces of the rotary 9 at both ends. With this configuration, the toner supply valve opening/closing unit 201 shared by the trays can control opening/closing of the toner supply valves 200 with respect to the toner cartridges of all colors.

### Image Forming Operation by Image Forming Apparatus

The image forming operation in the present embodiment will be described. In FIG. 1, the photosensitive drum 2 is rotated in an arrow direction of FIG. 1 (counterclockwise) in synchronization with rotation of an intermediate transfer belt 10. Then, the surface of the photosensitive drum 2 is uniformly charged by the charging roller 3. Along with this, the exposure device 4 emits laser light for a yellow image, thereby forming a yellow electrostatic latent image on the photosensitive drum 2.

At the same time as this formation of the electrostatic latent image, the rotary 9, which is a rotary support member capable of rotating, is rotated, and the yellow developing unit 5a is stopped at a developing position that opposes the photosensitive drum 2. Note that the rotary 9 is rotated by a non-illustrated driving source. At the developing position, the developing roller 51a provided in the yellow developing unit 5a is in contact with the photosensitive drum 2, and develops the electrostatic latent image using the yellow toner. That is to say, the rotary 9 rotates in an arrow direction of FIG. 1 (clockwise) while supporting the developing units 5a to 5d, thereby causing the four supported developing units 5a to 5d to move in sequence to the developing position opposing the photosensitive drum 2, one by one. The developing unit located at the developing position develops the electrostatic latent image formed on the photosensitive drum 2 in accordance with the color of the toner stored therein. RS rollers 52a to 52d rotate in the direction that is the same as, or the reverse of, the direction of the developing rollers 51a to 51d; consequently, toner remaining on the developing rollers 51a to 51d is stripped off, and new toner is supplied.

After the electrostatic latent image has been developed, a primary transfer roller 11 arranged inside the intermediate transfer belt 10 performs primary transfer of the yellow toner formed on the photosensitive drum 2 to the intermediate transfer belt 10.

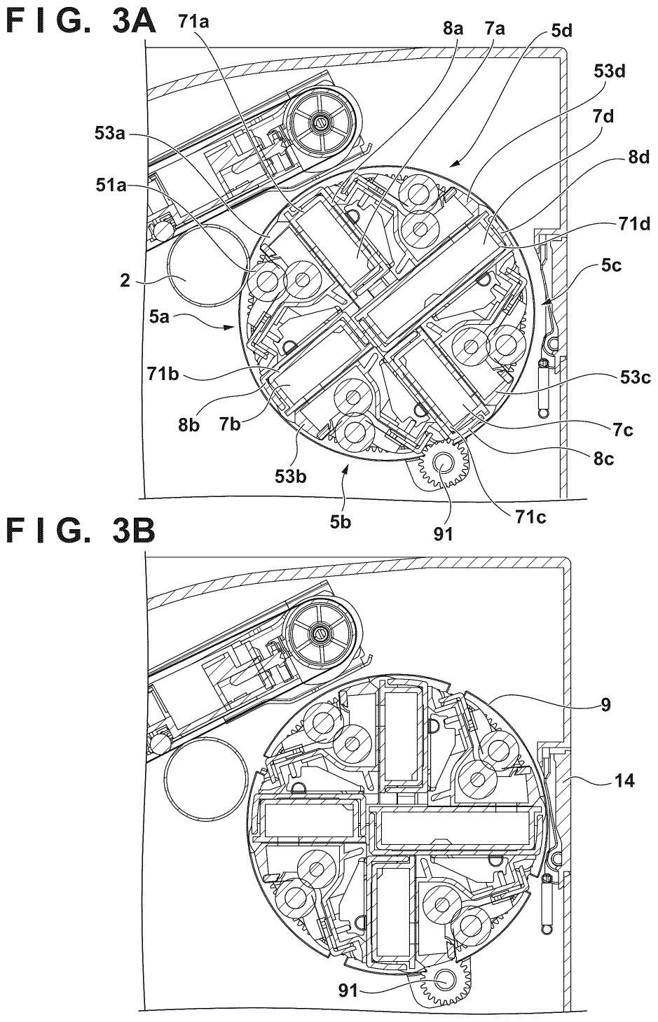

In the foregoing manner, the primary transfer of the yellow toner image is completed. Thereafter, the developing units 5b to 5d of the respective colors magenta, cyan, and black are rotated and moved by rotation of the rotary 9 and stop at the developing position 9X opposing the photosensitive drum 2 (see FIG. 3A), in sequence. Then, similarly to the case of yellow, the formation, development, and primary transfer of the electrostatic latent image are performed with respect to the colors magenta, cyan, and black, in sequence. As a result, toner images of four colors overlap one another on the intermediate transfer belt 10.

During the foregoing, a secondary transfer roller 12 is not in contact with the intermediate transfer belt 10. Furthermore, at this time, a cleaning apparatus 13 that removes remaining toner on the intermediate transfer belt 10 is not in contact with the intermediate transfer belt 10, either.

Meanwhile, sheets S as recording mediums are stacked and stored in a sheet storage unit 300 provided in a lower part of the image forming apparatus body 1. The sheets S are, for example, sheet-like mediums (sheet materials or cut sheets) obtained by cutting paper or the like in a predetermined size, and fed by a pickup roller 310. After each individual sheet S has been separated by a feed roller 311 and a separation roller 312, it is sent to a conveyance roller pair 320. The conveyance roller pair 320 sends the fed sheet S to a nip portion between the intermediate transfer belt 10 and the secondary transfer roller 12. The toner images of four colors that overlap one another on the intermediate transfer belt 10 are collectively transferred to the surface of the conveyed sheet S (secondary transfer).

The sheet S on which the toner images have been transferred is sent to a fixing device 40. In the fixing device 40, heat and pressure are applied to the sheet S, and the toner images are fixed onto the sheet S. As a result, a color image is formed on the sheet S. Then, this sheet S is discharged from the fixing device 40.

As described above, in the image forming operation according to the present embodiment, image creation units such as the photosensitive drum 2, the developing rollers 51a to 51d, and the intermediate transfer belt 10 are rotated by a non-illustrated driving source. Furthermore, paper feed/conveyance units such as the pickup roller 310, the feed roller 311, and the conveyance roller pair 320, as well as the fixing device 40, are also rotated by a non-illustrated driving source.

### Rotary Configuration

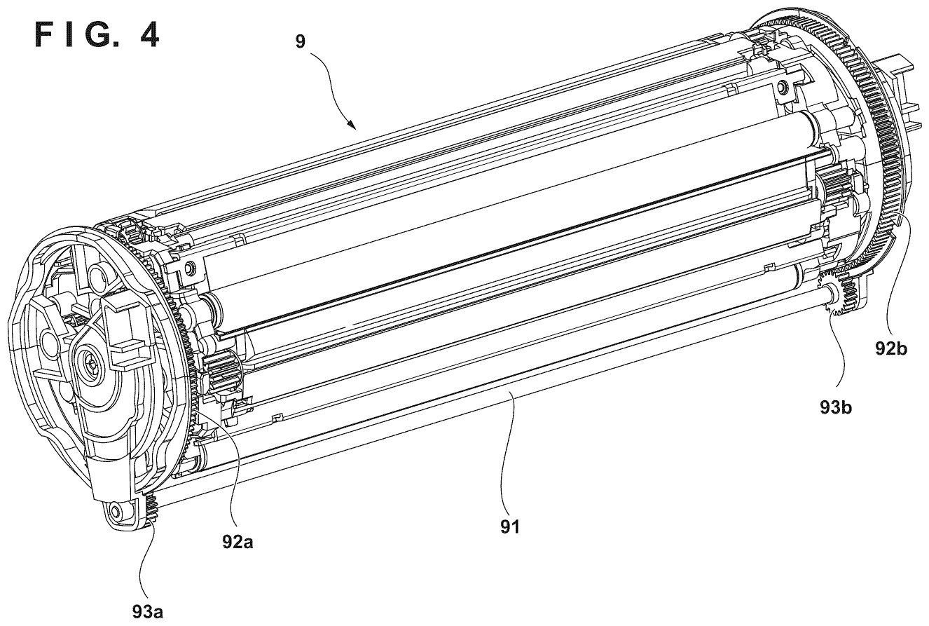

Using FIG. 3A to FIG. 4, a configuration of the rotary 9 will be described. FIG. 3A and FIG. 3B are cross-sectional diagrams of the rotary 9 and the surroundings thereof. FIG. 4 is an external view of the rotary 9.

As stated earlier, the toner cartridges 7a to 7d are attachable to and detachable from the rotary 9, and a user can exchange the toner cartridges 7a to 7d when toner inside the toner cartridges 7a to 7d has been depleted. At the time of exchange of a toner cartridge, the rotary 9 is stopped at the toner cartridge exchange position 9Y (see FIG. 3B).

FIG. 3A shows a cross-section of the rotary 9 and the surroundings thereof in a state where the rotary 9 is stopped at the developing position 9X. FIG. 3B shows a cross-section of the rotary 9 and the surroundings thereof in a state where the rotary 9 is stopped at the toner cartridge exchange position 9Y. As shown in FIG. 3A, the four trays 8a to 8d are arranged inside the rotary 9, and the toner cartridges 7a to 7d are held by the trays 8a to 8d, respectively. At this time, the toner cartridges 7a to 7d are in a state where they have been attached to the developing units 5a to 5d. In the present embodiment, the toner cartridge 7d storing black toner (hereinafter referred to as a black toner cartridge 7d) is larger in size than the toner cartridges of other colors, and capable of storing a large amount of toner. The toner cartridges of other colors are the toner cartridges 7a to 7c storing yellow toner, magenta toner, and cyan toner (hereinafter referred to as a yellow toner cartridge 7a, a magenta toner cartridge 7b, and a cyan toner cartridge 7c). Therefore, the tray 8d that holds the black toner cartridge 7d is larger in size than the trays 8a to 8c that hold the yellow toner cartridge 7a, the magenta toner cartridge 7b, and the cyan toner cartridge 7c. That is to say, the four toner cartridges 7a to 7d and the trays 8a to 8d that have different sizes are arranged inside the rotary 9. The toner in the toner cartridges 7a to 7d is supplied to the developing frame bodies 53a to 53d of the developing units 5, and used by the developing rollers 51a to 51d for development.

Here, the rotary 9 is supported so as to be swingable around a swing shaft 91. At the developing position 9X, the developing roller 51a is in contact with the photosensitive drum 2 as a non-illustrated force application member applies a force thereto. In the course of moving the rotary 9 to the toner cartridge exchange position 9Y by rotating it clockwise in the figure, a non-illustrated separation mechanism causes the rotary 9 to swing around the swing shaft 91, and the developing roller 51a becomes separated from the photosensitive drum 2. At the toner cartridge exchange position 9Y, the black toner cartridge 7d is stopped at a position that opposes the door 14 provided on the front surface of the image forming apparatus body 1. In this state, the user can exchange the black toner cartridge 7d by sliding and moving the tray 8d from the position of attachment to the developing unit 5d to the outside of the rotary 9. Note that a toner cartridge exchange operation will be described later.

Using FIG. 4, rotation and driving of the rotary 9 will be described. As shown in FIG. 4, disk gears 92a and 92b are formed at both ends of the rotary 9. Furthermore, rotary drive gears 93a and 93b are joined to both ends of the swing shaft 91 so as to be capable of transmitting the drive. Here, a non-illustrated driving source is transmitted to the rotary drive gear 93b, and the rotary drive gears 93a and 93b transmit a driving force to the disk gears 92a and 92b; as a result, the rotary 9 is rotated.

### Toner Cartridge Exchange Operation

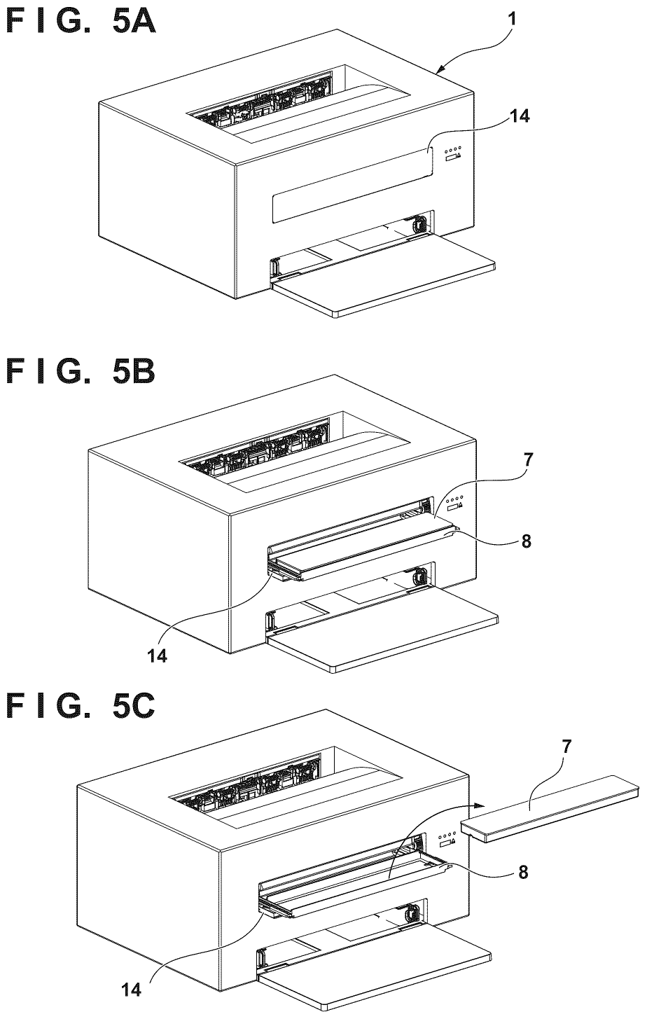

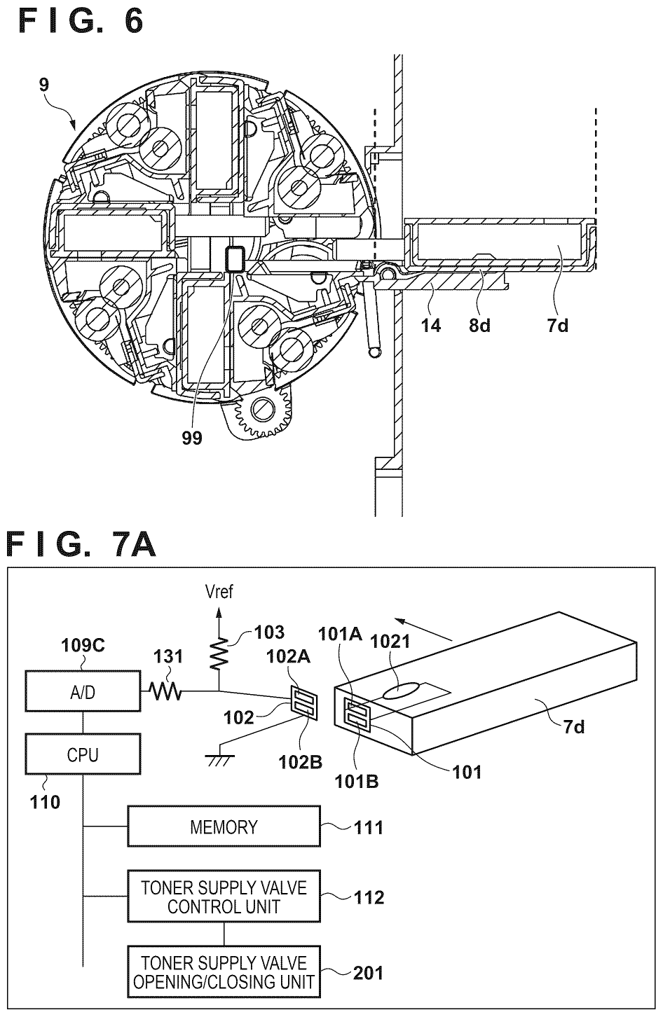

Using FIG. 5A to FIG. 6, the toner cartridge exchange operation will be described. FIG. 5A to FIG. 5C are external views of the image forming apparatus body 1. FIG. 6 is a cross-sectional diagram of the rotary and the surroundings thereof at the time of exchange of a toner cartridge.

FIG. 5A shows an external view of the image forming apparatus body 1 during the image forming operation and a standby state. At this time, the door 14 is in a closed state. FIG. 5B shows an external view of the image forming apparatus body 1 at the time of exchange of a toner cartridge. At this time, the door 14 is in an opened state, and a tray 8 and a toner cartridge 7 have moved to the outside of the image forming apparatus body 1.

The toner cartridge exchange operation will be described. First, when the user has issued an instruction for the toner cartridge exchange operation to the image forming apparatus body 1 (e.g., performed an operation of pressing an exchange button or the like), the rotary 9 is rotated and stopped at an exchange position of a toner cartridge 7 to be exchanged (a toner cartridge 7 in which toner has been depleted). Next, the non-illustrated drive transmission mechanism causes the tray 8 and the toner cartridge 7 to slide and move from the position of attachment to a developing unit 5 to the outside of the image forming apparatus body 1. At this time, the door 14 is supported so as to be pivotable relative to the image forming apparatus body 1, and the sliding movement of the tray 8 places the door 14 in the opened state (the state of FIG. 5B). Here, as the toner cartridge 7 is attachably/detachably held by the tray 8, the user can perform the exchange task by detaching the toner cartridge 7 from the tray 8 and attaching a new toner cartridge 7 as shown in FIG. 5C. Note that in a case where a plurality of toner cartridges 7 are to be exchanged, the exchange task can be performed by repeating the aforementioned operation.

FIG. 6 shows a cross-section of the rotary 9 and the surroundings thereof at the time of exchange of a toner cartridge. As shown in FIG. 6, at the time of exchange of a toner cartridge, as the user performs an operation of attaching/detaching the toner cartridge 7d via the tray 8d, the entirety of the toner cartridge 7d protrudes out of the image forming apparatus body 1 through the front surface thereof. This is the state shown in FIG. 5B. Furthermore, a toner tray storage detection sensor 99 is provided, which makes it possible to determine whether the tray 8 has been inserted and storing thereof has been completed.

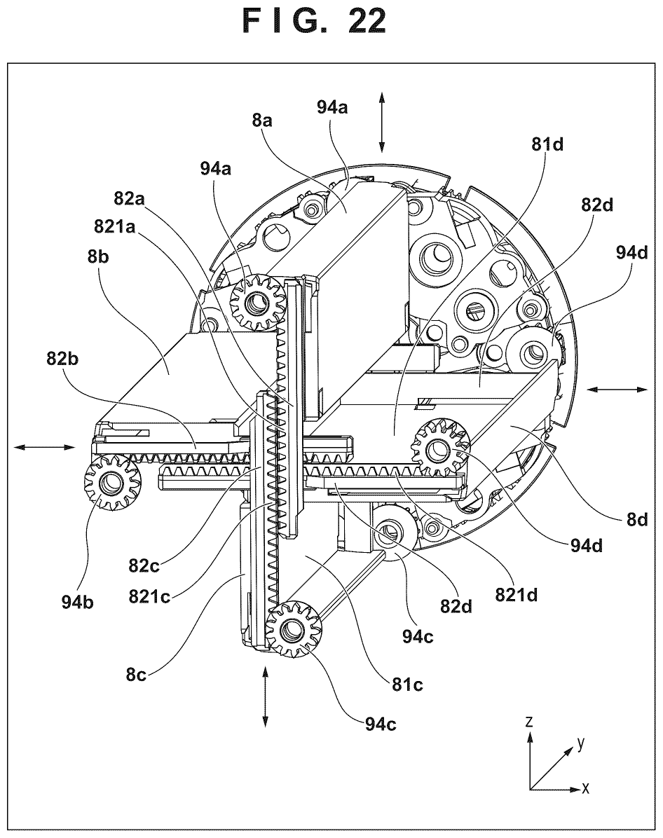

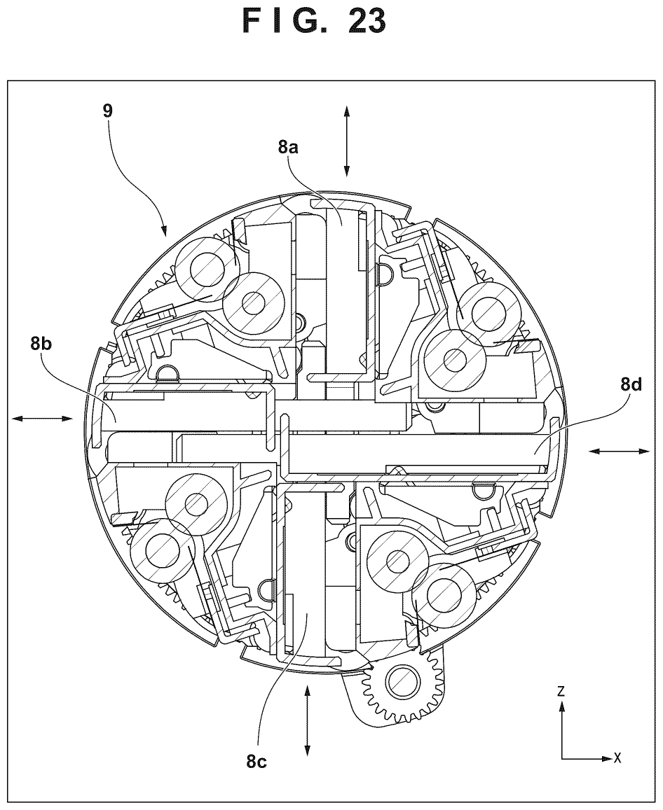

One example of the non-illustrated drive transmission mechanism is, for instance, a configuration in which the tray located at the exchange position is taken out of or inserted into the rotary by arranging racks along the sliding direction of the tray 8, and by rotating and driving gears that mesh with the racks. This configuration will be described with reference to FIG. 22 to FIG. 25B.

### Arrangement of Trays Inside Rotary

Using FIG. 22 and FIG. 23, the arrangement of the trays 8a to 8d inside the rotary 9 will be described. FIG. 22 is a perspective view showing the arrangement of the trays 8a to 8d inside the rotary 9. FIG. 23 is a cross-sectional diagram showing the arrangement of the trays 8a to 8d inside the rotary 9.

As shown in FIG. 22, the trays 8a to 8d include toner cartridge holding portions 81a to 81d and tray rails 82a to 82d, respectively (the toner cartridge holding portions 81a and 81b are not shown). The tray rails 82a to 82d are provided at both ends of the toner cartridge holding portions 81a to 81d. Rack portions 821a to 821d are formed on the tray rails 82a to 82d. Furthermore, rack gears 94a to 94d are rotatably held inside the rotary 9, and the rack gears 94a to 94d respectively mesh with the rack portions 821a to 821d so as to be capable of transmitting the drive.

Also, as shown in FIG. 22 and FIG. 23, the four trays 8a to 8d are arranged inside the rotary 9 in such a manner that they lie on top of one another. Their respective tray insertion/extraction directions are the directions of 90-degree rotation relative to one another (arrow directions in the figures). Therefore, each of a pair of the yellow tray 8a and the cyan tray 8c and a pair of the magenta tray 8b and the black tray 8d is held so as to be slidable and movable in the same direction. Each tray is displaced between a position where it is stored inside the rotary 9 and a position where it has been ejected to the outside of the rotary 9.

### Driving Configuration for Insertion/Extraction of Trays

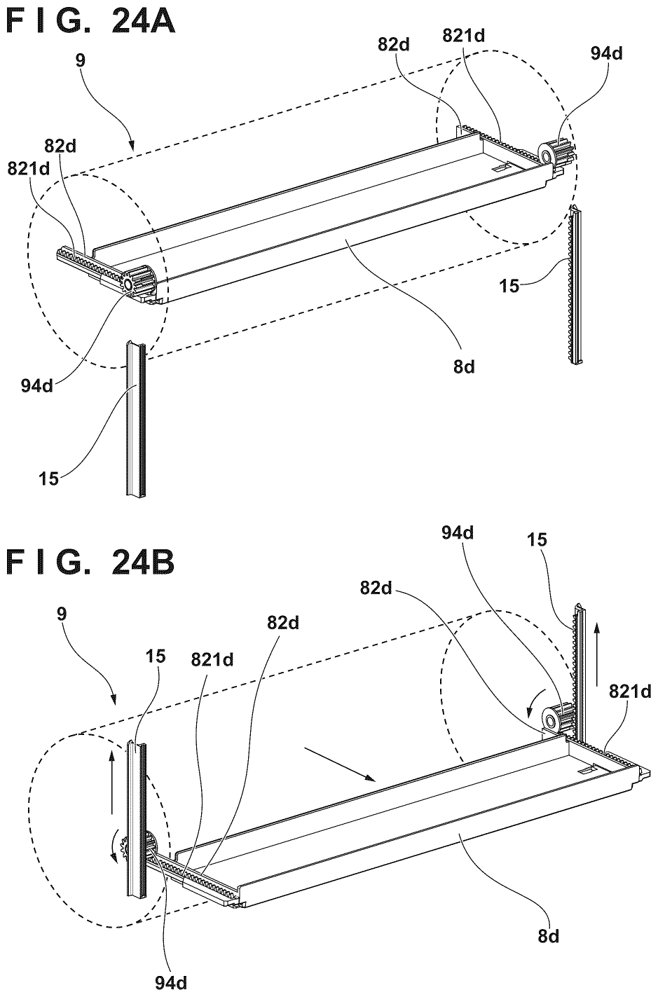

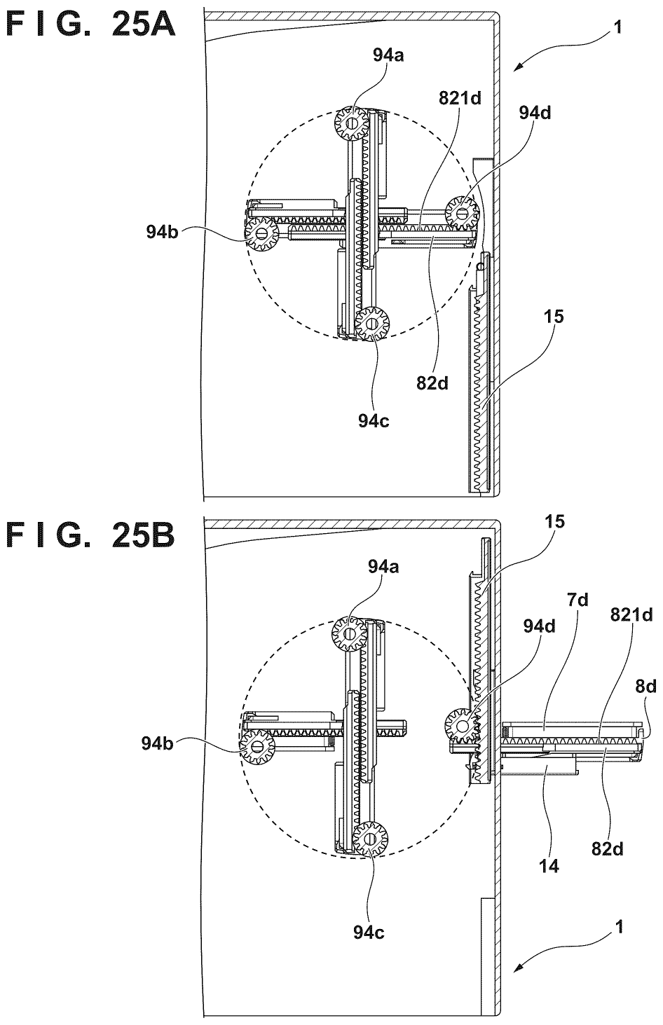

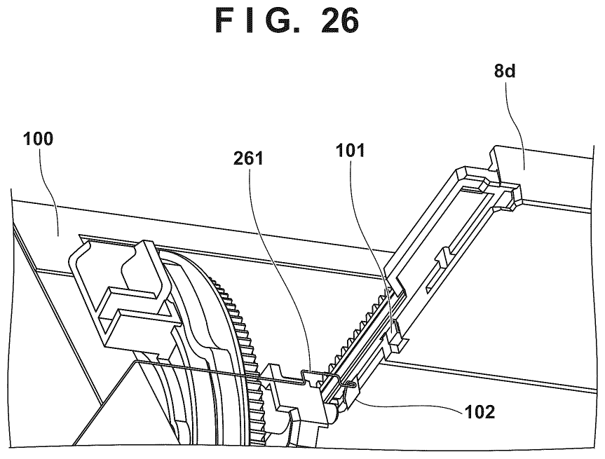

Using FIG. 24A to FIG. 25B, a driving configuration for insertion/extraction of the trays 8a to 8d arranged inside the rotary 9 will be described. FIG. 24A and FIG. 24B are perspective views showing the driving configuration for insertion/extraction of a tray. FIG. 25A and FIG. 25B are cross-sectional diagrams showing the driving configuration for insertion/extraction of a tray.

FIG. 24A shows a state where the tray 8d is inside the rotary 9 (i.e., a state where the toner cartridge 7d has been attached to the developing unit 5d). This position of the tray or cartridge is also referred to as a second position. FIG. 24B shows a state where the tray 8d has slid and moved to the outside of the rotary 9. This position of the tray or cartridge is also referred to as a first position. As stated earlier, two rack portions 821d are formed at both ends. Furthermore, two rack gears 94d and two driving racks 15 are also arranged at positions corresponding to the rack portions 821d at both ends. The tray 8d is held so as to be slidable and movable relative to the rotary 9 in the direction parallel to the tray rails 82d. The driving racks 15 are held so as to be slidable and movable relative to the image forming apparatus body 1 in the up-down direction. Although only the tray 8d is shown among the four trays 8a to 8d here, a driving configuration for insertion/extraction of the trays 8a to 8c is similar.

Using FIG. 25A and FIG. 25B, the following describes a tray insertion/extraction operation for sliding and moving the tray 8d from the inside of the rotary 9 (the position where the toner cartridge 7d is attached to the developing unit 5d) to the outside thereof. The operation of insertion/extraction of the tray 8d is performed by a non-illustrated driving source, the driving racks 15, the rack gears 94d, and the rack portions 821d. First, a driving force transmitted by the driving source causes the driving racks 15 to slide and move toward the upper side of the image forming apparatus body 1 and transmit the drive to the rack gears 94. The rack gears 94 rotate counterclockwise and transmit the drive to the rack portions 821d; consequently, the tray 8d slides and moves from the position of attachment of the toner cartridge 7d to the developing unit 5d toward the outside of the rotary 9.

Furthermore, an operation of sliding and moving the tray 8d to the inside of the rotary 9 after the toner cartridge has been exchanged can be performed by rotating and driving the driving source in the direction that is the reverse of the direction during the sliding movement of the tray 8d to the outside of the rotary 9. In this case, the driving racks slide and move toward the lower side of the image forming apparatus body 1; consequently, the tray 8d is retracted to the inside of the rotary 9. Note that the inside of the rotary 9 refers to the position where the toner cartridge 7d is attached to the developing unit 5d.

Also, a position of a toner cartridge 7 outside the rotary 9 may be referred to as a first position of a toner cartridge 7 or a tray 8, and a position of a toner cartridge 7 inside the rotary 9 may be referred to as a second position of a toner cartridge 7 or a tray 8. The first position and the second position are the positions of the tray 8 or the toner cartridge 7 shown in FIG. 25B and FIG. 25A, respectively. Furthermore, when focusing on a plurality of toner cartridges, a position of a toner cartridge 7 outside the rotary 9 may be referred to as a third position of a toner cartridge 7 or a tray 8. In this case, a position of a toner cartridge 7 inside the rotary 9 may be referred to as a fourth position of a toner cartridge 7 or a tray 8.

Configuration of Contact between Tray and Toner Cartridge

Using FIG. 26, a configuration of contacts between a body frame 100 and the toner cartridges 7a to 7d will be described. FIG. 26 is a perspective view showing connection between a contact portion 102 provided on a tray and the body. The contact portion 102 is connected, via a conductive member 261, to a non-illustrated electrical substrate that is provided in the body frame 100 and includes, for example, a control unit, a toner cartridge detection unit, and a drive control unit, which will be described later. The conductive member 261 is a metallic spring or the like, is affixed to the body frame 100 in an insulated state, holds the contact portion 102 in a state where the contact portion 102 is kept at a certain position relative to the tray 8, and is elastic for the purpose of secure contact with a contact 101 of a toner cartridge.

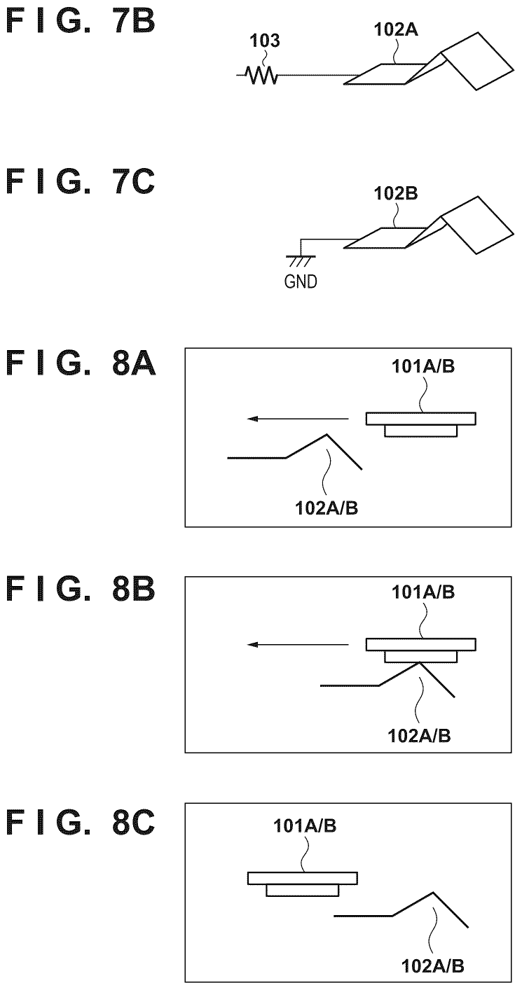

After the toner cartridge 7d has been attached to the tray 8d and the tray 8d has started moving from the first position where it is ejected to the outside of the rotary 9 to the second position where it is stored in the rotary 9, the contact 101 comes into contact with the contact portion 102 at a position during the movement or after the completion of the movement. Specifically, contact sites 101A and 101B included in the contact 101 become connected to contact members 102A and 102B included in the contact portion 102, respectively. As a result, for example, a current corresponding to a resistor value of a resistor element 1021 is generated in a circuit shown in FIG. 7A, and an input potential to an analogue-to-digital converter (A/D converter) 109C decreases in accordance with the resistor value of the resistor element 1021. Attachment of the toner cartridge 7d to the tray 8d can be detected. Although only the tray 8d and the toner cartridge 7d are shown among the four trays 8a to 8d and the four toner cartridges 7a to 7d here, a configuration of contacts between the trays 8a to 8c and the toner cartridges 7a to c is similar.

Note that the contact 101 of the toner cartridge may be referred to as a contact portion, and the contact portion provided on the tray of the body may be referred to as a contacted portion. Note that the contact 101 provided on the toner cartridge 7 and the contact portion 102 on the body side need not come into direct contact with each other. As the toner cartridge 7 is mounted on the tray 8, it is also permissible to adopt a structure in which the tray 8 is provided with an intermediate contact that comes into contact with the contact 101, and this intermediate contact comes into contact with the contact portion 102 on the body side by making this intermediate contact exposed also to the outside of the tray 8. Also, distinction may be made by referring to a contact portion of a first cartridge as a first contact portion, referring to a contact portion of a first cartridge as a second contact portion, and the like, depending on cartridges. Furthermore, distinction may be made by referring to a current value corresponding to a cartridge as a first current, a second current, and the like.

### Configuration for Distinguishing Toner Cartridge

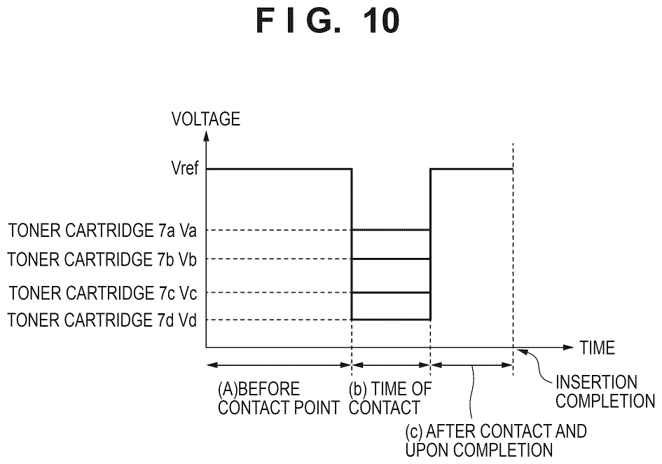

Using FIG. 7A to FIG. 11B, a method of distinguishing a toner cartridge will be described. FIG. 7A to FIG. 7C show a configuration of a distinction unit included in a toner cartridge, and a configuration of a detection unit inside the image forming apparatus 1 for distinguishing a toner cartridge. FIG. 9A to FIG. 9C show a flow until a toner cartridge 7 is inserted and distinguished based on the distinction unit and the insertion operation is completed at the time of exchange of the toner cartridge 7. Also, FIG. 10 shows values of a detection voltage of an A/D port of a CPU 110 from the time of insertion of the toner cartridge 7 to the completion of insertion when distinguishing the toner cartridge 7. Note that although the black toner cartridge 7d will be described as an example in the present embodiment, other toner cartridges 7a to 7c can also be distinguished using a similar configuration.

In FIG. 7A, an end surface of the toner cartridge 7d has the contact 101 including the two contact sites 101A and 101B, and the resistor element 1021 is provided inside the toner cartridge 7d for the purpose of distinction. Also, one of the terminals of this resistor element 1021 is connected to the contact site 101A, while the other is connected to the contact site 101B. The method of this connection may be, for example, soldering, or it is also permissible to adopt a configuration in which contact is established by, for example, tucking the terminals with a metal sheet or the like. Note that the resistor value of this resistor element 1021 varies with each of the toner cartridges 7a to 7d so that each of the toner cartridges 7a to 7d can be distinguished by the later-described A/D port.

Furthermore, the contact portion 102 including the contact members 102A and 102B, which are leaf springs and the like, is present inside the image forming apparatus 1, and is configured to come into contact with the aforementioned contact sites 101A and 101B when the toner cartridge 7d has been inserted. The contact portion 102 may be provided on the tray 8 as stated earlier, or may be provided outside the rotary 9.

The contact members 102A and 102B are, for example, leaf springs as shown in FIG. 7B and FIG. 7C, respectively, and are connected as follows. Note that although they are leaf springs in the present embodiment, other contact methods may be used. Also, the contact member 102B is connected to GND (i.e., grounded), and the contact member 102A is connected to an input port of the A/D converter 109C of the CPU 110 responsible for control on the image forming apparatus 1 via a resistor 103 and a series resistor 131. The other side of the resistor 103 is connected to a power source Vref. When these contact members 102A and 102B have come into contact with the contact sites 101A and 101B, an input voltage of the A/D converter 109C changes depending on the resistor value of the resistor 1021. Note that although the A/D converter 109C may be an A/D converter included in the CPU 110, FIG. 7A shows a configuration in which the A/D converter 109C is an A/D converter that is not included in the CPU 110, and a value that has been digitalized therethrough is input to the CPU 110.

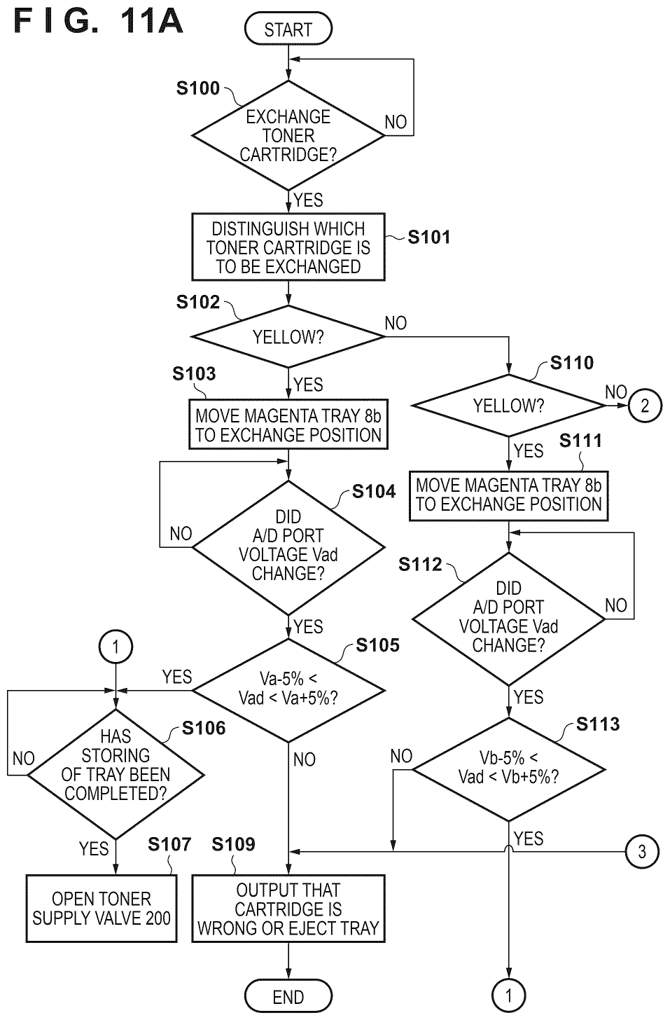

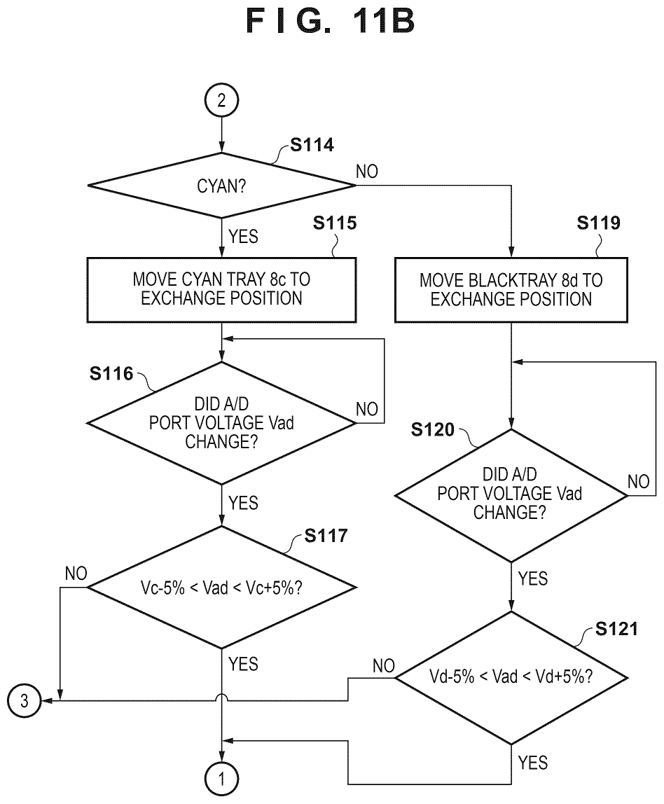

The A/D converter 109C converts the input voltage into a digital value corresponding to the voltage, and inputs the digital value to the CPU 110. The CPU 110 executes a program stored in a memory 111, stores the input digital value into, for example, the memory 111, and controls a toner supply valve control unit 112 in a later-described procedure of, for example, FIG. 11A and FIG. 11B to open the toner supply valve opening/closing unit 201 or leave it unopened.

FIG. 8A to FIG. 8C are diagrams showing states of contact between the contact 101A/B of the toner cartridge 7d and the contact portion 102A/B of the image forming apparatus until the toner cartridge 7d is inserted and the insertion is completed. FIG. 8A shows a state before the contact sites 101A and 101B come into contact with the contact members 102A and 102B, and is a state before the tray 8 to which the toner cartridge 7 has been attached is stored in the rotary 9. FIG. 8B shows a state of the time when the contact sites 101A and 101B have come into contact with the contact members 102A and 102B, and this state is achieved temporarily in the course of storing the tray 8 to which the toner cartridge 7 has been attached into the rotary 9. FIG. 8C shows a state after contact has been established between the contact sites 101A and 101B and the contact members 102A and 102B, and this state is achieved when the tray 8 is further inserted into the rotary 9 from the state of FIG. 8B. That is to say, storing of the tray 8 to which the toner cartridge 7 has been attached into the rotary 9 undergoes the states of FIG. 8A to FIG. 8C. Among these, at the time of FIG. 8B, the contact sites 101A and 101B come into contact with the contact members 102A and 102B, a current flows through the resistor 1021 inside the toner cartridge 7 upon formation of a closed circuit including the resistor 1021, and the voltage of the A/D converter 109C changes depending on the resistor value thereof. As the resistor value varies with each color of toner stored in the toner cartridges, this voltage values makes it possible to detect which color the inserted toner cartridge has.

FIG. 9A to FIG. 9C show the positions of the contact 101A/B in the toner cartridge 7 and the contact portion 102A/B in the image forming apparatus 1, and a flow from the time of insertion to the completion of insertion when the toner cartridge 7 is inserted at the time of exchange. As shown in FIG. 9A to FIG. 9C, the contact portion 102 is positioned midway between the point of insertion of the toner cartridge 7d and the point of closure of the door 14 upon completion of the insertion. Note that the toner supply valve 200, which is configured to slide for toner supply, is provided in an upper part of the toner cartridge 7. This toner supply valve 200 is normally in the closed state; when supplying toner, this toner supply valve 200 can be placed in a toner suppliable state by slide-opening the toner supply valve 200. Also, the image forming apparatus 1 is provided with the toner supply valve opening/closing unit 201 for opening or closing this toner supply valve 200. This is configured to, for example, cause a mechanical member to catch a hook provided on the toner supply valve 200 and slide the toner supply valve 200 using an electrical component acting as a driving source, such as a solenoid and a motor, and is configured to drive the solenoid to open the toner supply valve 200. Note that this is an example, and other configurations may be used.

In a case where the toner cartridge 7d has been determined to be a predetermined toner cartridge, the toner supply valve opening/closing unit 201 slides the toner supply valve, thereby placing the toner supply valve in the toner suppliable state. On the other hand, in a case where the toner cartridge 7d has not been determined to be the predetermined toner cartridge, the toner supply valve 200 is not caused to perform the slide operation, thereby leaving the opening thereof in the closed state.

FIG. 9A shows a state before the contact 101A/B comes into contact with the contact member 102A/B of the image forming apparatus with the toner cartridge 7d mounted on the tray, FIG. 9B shows a state where the contact 101A/B is in contact with the contact member 102A/B, and FIG. 9C shows a state of the contact sites at the time of completion of insertion. In these states, the contact sites 101A/B and the contact members 102A/B are in the states shown in FIG. 8A, FIG. 8B, and FIG. 8C, respectively.

FIG. 10 shows values of an input voltage (i.e., a detection voltage) of the A/D converter 109C from the time of insertion of a toner cartridge 7 to the completion of insertion when distinguishing the toner cartridge 7; a vertical axis represents a voltage, and a horizontal axis represents time from the time of insertion of the toner cartridge 7 to the completion of insertion. According to FIG. 10, before contact is established, namely in FIG. 9A, the contact sites 101A and 101B of the toner cartridge 7d are not in contact with the contact members 102A and 102B of the image forming apparatus, and thus a voltage of Vref (V) is input to the A/D port. Also, when the toner cartridge 7d is inserted and the contact sites 101A and 101B have come into contact with the contact members 102A and 102B in the midst of insertion, namely in FIG. 9B, the input voltage of the A/D port is a divided voltage through the resistances of the resistor 103 and the resistor 1021. Therefore, a voltage value thereof is Vref x (the resistor value of the resistor 1021/(the resistor value of the resistor 103 +the resistor value of the resistor 1021)). In the example of the toner cartridge 7d, when contact is established, the divided voltage is Vd (V). Also, when the cartridge 7d is further inserted inside, namely in the state of FIG. 9C, 101A and 101B (also referred to as 101A/B) become out of contact with 102A and 102B (also referred to as 102A/B) again, and a voltage of Vref is input.

Provided that the resistor value of the resistor 103 is R and the resistor values of the resistors 1021 are Ra, Rb, Rc, and Rd for Y, M, C, and K, respectively, Va to Vd of FIG. 10 are as follows. Va to Vd may be referred to as reference voltages of the respective colors.

$$Va = Vref \times Ra / ( R + Ra ) \\ Vb = Vref \times Rb / ( R + Rb ) \\ Vc = Vref \times Rc / ( R + Rc ) \\ Vd = Vref \times Rd / ( R + Rd )$$

These voltage values are converted into digital values by the A/D converter, input to the CPU 110, and detected.

Also, as the resistors 1021 have different resistor values Ra to Rd for different colors of the respective toner cartridges 7, namely 7a to 7d as stated earlier, the divided voltage when 101A and 101B have come into contact with 102A and 102B varies with each cartridge. This makes it possible to determine which toner cartridge has been inserted. In the present example, as the magnitudes of the resistor values are set to decrease in the order of the toner cartridge 7a>7b>7c>7d, the divided voltage values are set to decrease in the order of Va>Vb>Vc>Vd; however, no limitation is intended by this. Furthermore, as there is variation in the detected voltage for each individual toner cartridge, it is desirable that, at the time of the detection, the detected voltage be compared with voltages that have a range of voltage values to some extent (e.g., the detected voltage should be within ±5% of these voltages).

In this way, in which toner cartridge tray a toner cartridge is to be exchanged is determined in advance, and the detected voltage is compared with the preset voltage values of the respective toner cartridges; as a result, whether a toner cartridge is a predetermined toner cartridge can be distinguished. The toner cartridge to be exchanged may be designated from, for example, an operation unit provided in the image forming apparatus, such as an operation panel.

Next, a flow of determining whether a toner cartridge is a predetermined toner cartridge will be described using a flowchart. FIG. 11A and FIG. 11B represent the present flowchart. The flowchart of FIG. 11A and FIG. 11B shows a procedure of a program that is read out from the memory 111 and executed by the CPU 110. That is to say, the CPU 110 is the main executor of each step of FIG. 11A and FIG. 11B.

First, whether a toner cartridge is to be exchanged is determined (step S100), and in a case where the exchange is to be performed, which toner cartridge is to be exchanged is distinguished (step S101). It is sufficient for these determination and distinction to be based on an instruction issued by a user from the operation unit. For example, when an instruction for exchanging the black toner cartridge has been issued from the operation unit, it can be distinguished that a toner cartridge is to be exchanged, and further that the exchange target is the black toner cartridge 7d.

First, the CPU 110 determines whether the toner cartridge to be exchanged based on the instruction is the yellow toner cartridge 7a (step S102). If the exchange target is the yellow toner cartridge 7a, the CPU 110 causes the yellow tray 8a to move to the exchange position (also referred to as a cartridge exchange opening 14) by rotating the rotary 9 (step S103). If the image forming apparatus 1 has a function of moving a tray 8 located at the exchange position between a state where it is stored in the rotary 9 and a state where it is exposed through the door 14 (referred to as a tray moving function), the tray 8a may be moved to the outside of the door 14 in step S103. Otherwise, a worker may manually pull out the tray 8a through the door 14.

In this state, the worker detaches the toner cartridge 7a from the tray 8a and exchanges the same to a new toner cartridge. If the image forming apparatus has the tray moving function, for example, when the worker has performed an operation indicating that the exchange has been done after the exchange, the CPU 110 accordingly causes the tray 8a to move to the inside of the rotary 9. On the other hand, if there is no tray moving function, the worker manually pushes the tray 8a into the inside of the rotary 9.

After step S103, the CPU 110 monitors whether a voltage value Vad input to the A/D port has changed (step S104). In the state of step S103, the detected voltage value is Vref; thus, a fluctuation from this value is monitored. However, as a certain extent of change is tolerated, it may be determined that the change has occurred when the change exceeds a predetermined value. The predetermined value may be set as a percentage (e.g., 10%), or, for example, it may be determined that the fluctuation has occurred when the fluctuation exceeds an intermediate value between a post-fluctuation voltage value and an expected post-fluctuation voltage value (e.g., (Vref−Va)/2).

In a case where it is determined that the fluctuation has occurred, the CPU 110 determines whether the voltage Vad detected after the change is equal to the reference voltage of the color of the exchange target (step S105). Here, as the exchange target is yellow, whether Vad is equal to Va is determined. Note that a match with ±5% range of the reference value is accepted here in consideration of variation, such as individual differences.

In a case where it is determined that the voltages match in step S105, the CPU 110 determines whether storing of the exchange-target toner cartridge 7 into the rotary 9 has been completed (step S106). It is sufficient that this determination be made based on, for example, a signal detected by the tray storage detection sensor 99. Alternatively, the positional relationship between the contact site 101 and the contact member may be set so that storing of the tray 8 is completed when the tray 8 is at a position where the detected voltage Vad is restored to Vfd from the voltage corresponding to the color component. In this way, it can be determined that storing of the tray 8 and the toner cartridge 7 into the rotary 9 has been completed when the tray 8 is at the position where the detected voltage Vad is restored to Vfd from the voltage corresponding to the color component.

Upon completion of storing of the toner cartridge 7, the CPU 110 drives the toner supply valve opening/closing unit 201 by controlling a toner supply valve control unit 112, thereby opening the toner supply valve 200 of the yellow toner cartridge 7a (step S107).

On the other hand, in a case where it is determined that the voltages do not match in step S105, the CPU 110 outputs a warning indicating that the cartridge 7 is a cartridge of a color that does not correspond to the tray 8 using, for example, a display, a sound, and the like while leaving the toner supply valve 200 closed (step S109). At this time, the image forming apparatus may eject the yellow tray 8a to the outside of the rotary 9 if it has the tray moving function. This operation may be performed in coordination with the output of the warning.

If the exchange target is not the yellow toner cartridge, the CPU 110 determines whether the exchange target is the magenta toner cartridge (step S110); if the exchange target is not the magenta toner cartridge, the CPU 110 determines whether the exchange target is the cyan toner cartridge (step S114). If the exchange target is the magenta toner cartridge, the CPU 110 executes processing similar to steps S103 to S105 in steps S111 to S113. Note that as the color of the exchange target is magenta, processing executed here is different from steps S103 to S105 in that the tray and the reference voltage correspond to magenta, that is to say, they are the tray 8b and the reference voltage Vb. Also, if the exchange target is the cyan toner cartridge, the CPU 110 executes processing similar to steps S103 to S105 in steps S115 to S117. Note that as the color of the exchange target is cyan, processing executed here is different from steps S103 to S105 in that the tray and the reference voltage correspond to cyan, that is to say, they are the tray 8c and the reference voltage Vc. If the exchange target is not any of the above, the exchange target is the black toner cartridge, and thus the CPU 110 executes processing similar to steps S103 to S105 in steps S119 to S121. Note that as the color of the exchange target is black, processing executed here is different from steps S103 to S105 in that the tray and the reference voltage correspond to black, that is to say, they are the tray 8d and the reference voltage Vd.

Through the aforementioned operation, it is determined that a developer container, namely a toner cartridge has been exchanged, and also, whether the post-exchange developer container, namely toner cartridge is a toner cartridge corresponding to a tray is determined. If the determination results indicate that a toner cartridge of a wrong color has been inserted, a toner opening/closing unit, namely a lid cannot be opened; therefore, mixing of toner of a wrong color inside a developing device can be prevented.

### Second Embodiment

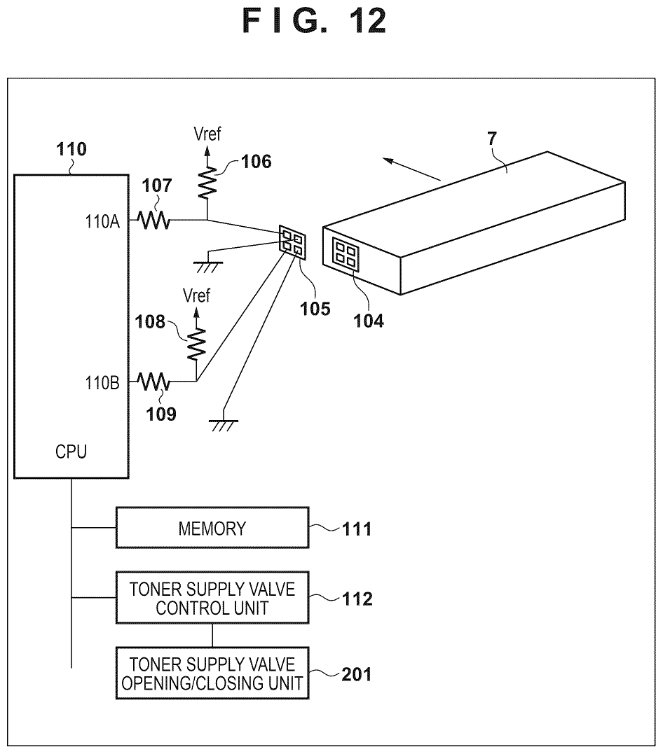

Using FIG. 12 to FIG. 17B, a method of distinguishing a toner cartridge according to the present embodiment will be described.

In the first embodiment, a resistor and contact sites are provided in a toner cartridge 7 to distinguish the toner cartridge, and the distinction is made based on a resistor value thereof. In contrast, according to the present embodiment, a toner cartridge is provided with a plurality of contacts, and which toner cartridge 7 has been inserted is distinguished depending on a state between contacts (open-circuited or short-circuited). Therefore, the configuration in which the toner cartridges 7 include the toner supply valves 200 and the image forming apparatus 1 includes the toner supply valve opening/closing unit 201 is similar to the first embodiment.

FIG. 12 to FIG. 16 show a configuration of a distinction unit included in a toner cartridge, and a configuration of a detection unit inside the image forming apparatus 1 for distinguishing a toner cartridge.

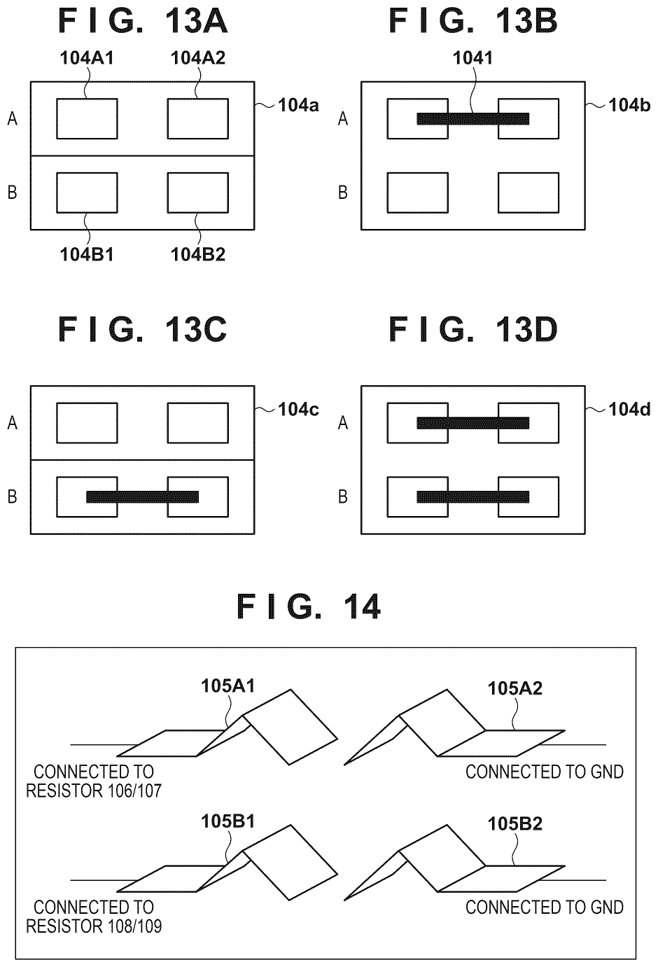

In FIG. 12, an end surface of a toner cartridge 7 has a contact 104 including four contact sites 104A1, 104A2, 104B1, and 104B2, which will be described later using FIG. 13A to FIG. 13D. These contact sites are composed of two pairs of contact sites (or electrodes), namely a pair of contact sites 104A1 and 104A2 and a pair of contact sites 104B1 and 104B2.

FIG. 13A to FIG. 13D are detailed diagrams of these contact sites 104. As shown in these FIG. 13A to FIG. 13D, the state between the contact sites 104A1 and 104A2 and between the contact sites 104B1 and 104B2, namely whether they are open-circuited or short-circuited, varies with each of the colors of the toner cartridges 7, and they are designed so that a toner cartridge 7 can be distinguished by detecting this state.

For example, regarding the contact sites 104a of the yellow toner cartridge 7a, the contact sites 104A1 and 104A2, as well as the contact sites 104B1 and 104B2, are in an open-circuit state. Regarding the contact sites 104b of the magenta toner cartridge 7b, the contact sites 104A1 and 104A2 are connected by a conductive body 1041 and thus short-circuited, while 104B1 and 104B2 are open-circuited. Also, regarding the contact sites 104c of the cyan toner cartridge 7c, the contact sites 104A1 and 104A2 are open-circuited, while 104B1 and 104B2 are short-circuited; regarding the contact sites 104d of the black toner cartridge 7d, the contact sites 104A1 and 104A2 are short-circuited, and 104B1 and 104B2 are also short-circuited.

Furthermore, in FIG. 12, a contact portion 105 including contact members 105A1, 105A2, 105B1, and 105B2, which are leaf springs and the like, is provided inside the image forming apparatus 1. The contact members 105A1, 105A2, 105B1, and 105B2 are arranged respectively at positions that correspond to the aforementioned contact sites 104A1, 104A2, 104B1, and 104B2 when a toner cartridge 7 has been inserted. Also, as shown in FIG. 14, the contact members 105A1, 105A2, 105B1, and 105B2 are leaf springs, for example. Note that although they are leaf springs in the present embodiment, other contact methods may be used. Note that, similarly to the first embodiment, these contact members 105 are positioned midway between the point of insertion of the toner cartridge 7 and the point of closure of the door 14 upon completion of the insertion. Therefore, in the midst of storing of the toner cartridge 7 mounted on a tray 8 into the rotary 9, the contact sites and the contact members that correspond to one another come into contact with one another.

Also, as shown in FIG. 12, the contact members 105A2 and 105B2 are connected to the ground (GND), and the contact member 105A1 is connected, via a resistor 106 and a series resistor 107, to an I/O port 110A of the CPU 110 responsible for control on the image forming apparatus 1. The other side of the resistor 106 is connected to a power source Vref. Furthermore, the contact member 105B1 is configured in a similar manner; it is connected, via a resistor 108 and a series resistor 109, to an I/O port 110B of the CPU 110 responsible for control on the image forming apparatus 1, and the other side of the resistor 108 is connected to the power source Vref. Here, each resistor value of FIG. 12 may be adjusted so that the input voltages to the I/O ports 110A and 110B become the same as the signal level of the CPU 110. Therefore, the signal level of the I/O port 110A (and the I/O port 110B) is a low level when the contact portions A are short-circuited, and a high level when they are open-circuited, as shown in FIG. 13A to FIG. 13D, for example. However, signals may not be input directly to the I/O ports of the CPU 110, and they may be input to the CPU 110 after being digitalized through A/D conversion, similarly to the first embodiment. In this case, too, it is sufficient that the input signals indicate one of the high level and the low level. In either case, it is sufficient that the CPU 110 be capable of obtaining information indicating whether the contact sites 104A and the contact sites 104B are short-circuited or open-circuited.

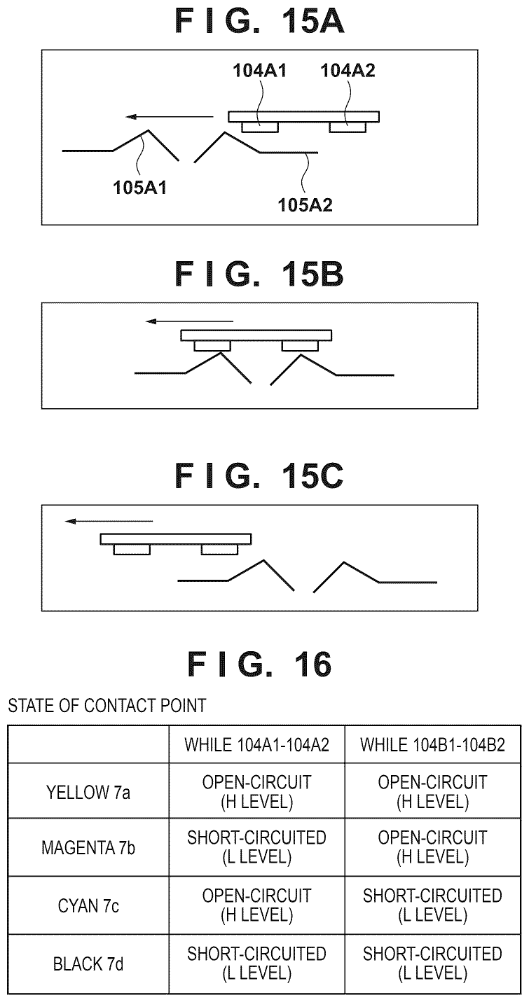

Also, FIG. 15A to FIG. 15C are bird's-eye views of a toner cartridge 7, and show a transition in a state of contact between the contact sites 104A1 and 104A2 of the toner cartridge 7 and the contact members 105A1 and 105A2 of the image forming apparatus. FIG. 15A shows a state before contact is established, FIG. 15B shows a state where contact is established, and FIG. 15C shows a state of the contact sites after the establishment of contact and at the time of completion of storing of the toner cartridge. In the state where contact is established as shown in FIG. 15B, if the contact site 104A1 and the contact site 104A2 are short-circuited, the contact members 105A1 and 105A2 become connected to each other. On the other hand, if the contact site 104A1 and the contact site 104A2 are open-circuited, the contact members 105A1 and 105A2 do not become connected to each other. Furthermore, in the course of reaching FIG. 15B from FIG. 15A, and in the course of reaching FIG. 15C from FIG. 15B, it is possible that only one contact site comes into contact with a contact member. However, in this case, even if the contact site 104A1 and the contact site 104A2 are short-circuited, the contact members 105A1 and 105A2 do not become connected to each other.

In view of this, the CPU 110 distinguishes a toner cartridge by detecting signal values of the respective I/O ports 110A and 110B. Note that with the foregoing configuration, depending on whether the contact sites 104A1 and 104A2 and the contact sites 104B1 and 104B2 of the toner cartridge 7d are open-circuited or short-circuited, the states of the I/O port 110A and the I/O port 110B change between the H level at the time of open-circuit and the L level at the time of short-circuit. This state is shown in FIG. 16.

In this FIG. 16, the leftmost column indicates the names of colors, namely yellow 7a, magenta 7b, cyan 7c, and black 7d, of the respective toner cartridges 7. Also, two columns on the right of this column indicate the states of contacts, with parentheses showing a high voltage level (H level) and a low voltage level (L level) input to the I/O port 110A and the I/O port 110B.

In the case of yellow 7a, 104A1 and 104A2, as well as 104B1 and 104B2, are open-circuited; in this case, they both cause the H level. In the case of magenta 7b, 104A1 and 104A2 are short-circuited and thus cause the L level, whereas 104B1 and 104B2 are open-circuited and thus cause the H level. In the case of cyan 7c, 104A1 and 104A2 are open-circuited and thus cause the H level, whereas 104B1 and 104B2 are short-circuited and thus cause the L level. In the case of black 7d, 104A1 and 104A2, as well as 104B1 and 104B2, are short-circuited; in this case, they both cause the L level. This makes it possible to distinguish which color the inserted toner cartridge 7 has. Note that regarding the yellow toner cartridge 7a, neither the value of the I/O port 110A nor the value of the I/O port 110B changes from the H level after the toner cartridge 7a has been exchanged until a post-exchange toner cartridge is stored in the rotary 9. In view of this, in a case where the yellow toner cartridge 7a is the exchange target, it is determined that the post-exchange toner cartridge is the yellow toner cartridge 7a when the tray storage detection sensor 99 has detected the completion of storing of a tray. Note that the tray storage detection sensor 99 detects the toner cartridge 7 attached to the tray 8, rather than the tray 8. Even if the tray 8 is stored in the rotary 9 without a toner cartridge attached thereto, the foregoing configuration prevents detection of a state where a toner cartridge 7 has been stored.

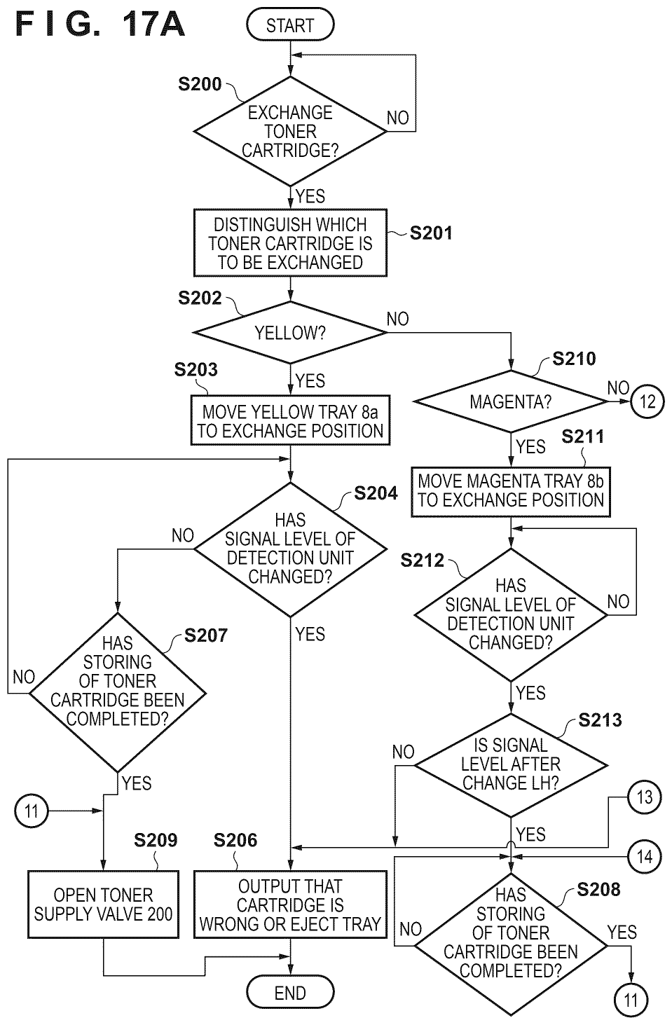

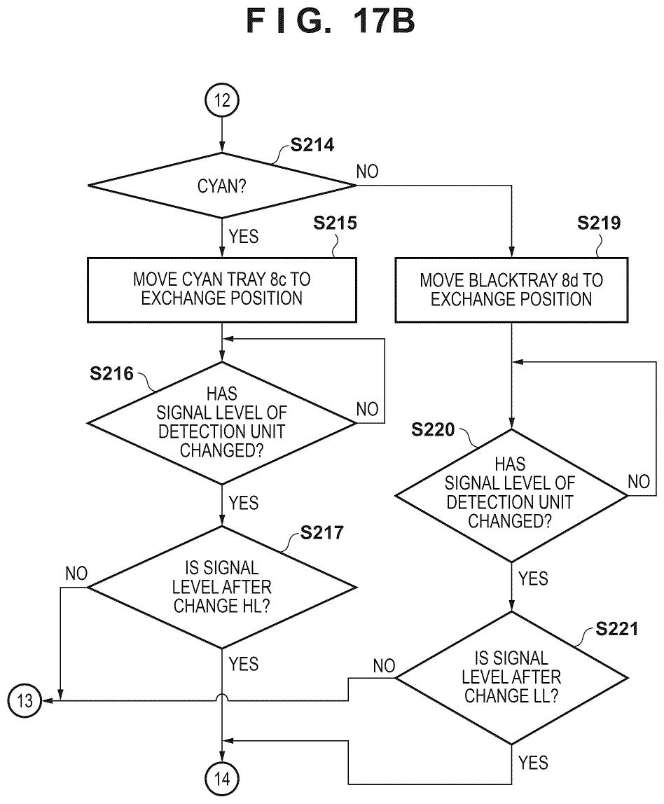

Next, a flow of determining whether a toner cartridge is a predetermined toner cartridge will be described using a flowchart of FIG. 17A and FIG. 17B. A procedure of FIG. 17A and FIG. 17B is also realized by the CPU 110 executing a program stored in the memory 111.

First, whether a toner cartridge is to be exchanged is determined (step S200), and in a case where the exchange is to be performed, which toner cartridge is to be exchanged is distinguished (step S201). It is sufficient for these determination and distinction to be based on an instruction issued by a user from the operation unit. For example, when an instruction for exchanging the black toner cartridge has been issued from the operation unit, it can be distinguished that a toner cartridge is to be exchanged, and further that the exchange target is the black toner cartridge 7d.

First, the CPU 110 determines whether the toner cartridge to be exchanged based on the instruction is the yellow toner cartridge 7a (step S202). If the exchange target is the yellow toner cartridge 7a, the CPU 110 causes the yellow tray 8a to move to the exchange position (also referred to as a cartridge exchange opening 14) by rotating the rotary 9 (step S203). If the image forming apparatus 1 has a function of moving a tray 8 located at the exchange position between a state where it is stored in the rotary 9 and a state where it is exposed through the door 14 (referred to as a tray moving function), the tray 8a may be moved to the outside of the door 14 in step S203. Otherwise, a worker may manually pull out the tray 8a through the door 14.

In this state, the worker detaches the toner cartridge 7a from the tray 8a and exchanges the same to a new toner cartridge. If the image forming apparatus has the tray moving function, for example, when the worker has performed an operation indicating that the exchange has been done after the exchange, the CPU 110 accordingly causes the tray 8a to move to the inside of the rotary 9. On the other hand, if there is no tray moving function, the worker manually pushes the tray 8a into the inside of the rotary 9.

After step S203, the CPU 110 monitors the signal levels of the detection unit, that is to say, the signal levels of the I/O ports 110A and 110B, and determines whether at least one of them has changed from the H level (step S204). In the present embodiment, regarding the contact 104 of the yellow toner cartridge 7a, the contact sites 104A1 and 104A2, as well as the contact sites 104B1 and 104B2, are in an open-circuit state. Therefore, even if the contact portion 105 comes into contact with the contact sites 104 of the yellow toner cartridge 7a, the signal level of the I/O port 110A or 110B remains at the H level, that is to say, remains unchanged. If this signal level changes, it means that an unsuitable toner cartridge has been attached to the tray 8a. Therefore, in this case, the CPU 110 outputs a warning indicating that the cartridge 7 is a cartridge of a color that does not correspond to the tray 8 using, for example, a display, a sound, and the like while leaving the toner supply valve 200 closed (step S206). At this time, the image forming apparatus may eject the yellow tray 8a to the outside of the rotary 9 if it has the tray moving function. This operation may be performed in coordination with the output of the warning.

On the other hand, in a case where neither of the signal levels of the I/O ports 110A and 110B has changed, there is a possibility that the yellow toner cartridge 7a has been attached to the tray 8a. Therefore, in this case, the CPU 110 determines whether storing of the toner cartridge 7 attached to the tray 8a into the rotary 9 has been completed (step S207). It is sufficient that this determination be made based on, for example, a signal detected by the tray storage detection sensor 99. Here, the tray storage detection sensor 99 detects that the tray has been stored through detection of the toner cartridge 7 attached to the tray 8. This can prevent storing of an unloaded tray into the rotary 9 from being erroneously recognized as the exchange of the yellow toner cartridge 7a.

In a case where it is determined that storing of the toner cartridge 7 into the rotary 9 has been completed in step S207, it means that the toner cartridge 7 has been stored without any change in the signal levels of the detection unit. It can be determined that such a toner cartridge 7 is the yellow toner cartridge 7a. Accordingly, the CPU 110 drives the toner supply valve opening/closing unit 201 by controlling the toner supply valve control unit 112, thereby opening the toner supply valve 200 of the yellow toner cartridge 7a (step S209).

In a case where it is determined that the toner cartridge to be exchanged is not the yellow toner cartridge in step S202, whether the toner cartridge to be exchanged is the magenta toner cartridge is determined (step S210). If the exchange target is the magenta toner cartridge 7b, the CPU 110 causes the magenta tray 8b to move to the exchange position (step S211). Thereafter, the exchange task is similar to step S203, except for the difference in the color of the toner cartridge.

After step S211, the CPU 110 monitors the signal levels of the detection unit, that is to say, the signal levels of the I/O ports 110A and 110B, and determines whether at least one of them has changed from the H level (step S212). In the present embodiment, regarding the contact 104 of the magenta toner cartridge 7b, the contact sites 104A1 and 104A2 are short-circuited, while the contact sites 104B1 and 104B2 and open-circuited. Therefore, when the detection unit has detected a change in the signal levels, the CPU 110 determines whether the changed signal levels are LH, that is to say, the I/O port 110A is at the L level and the I/O port 110B is at the H level (step S213). Note that in the following description, too, the signal levels detected by the detection unit are presented in the order of the I/O port 110A and the I/O port 110B.

If it is determined that the changed signal levels are LH in step S213, it can be determined that the post-exchange toner cartridge 7 is the magenta toner cartridge 7b, and the CPU 110 accordingly waits for the toner cartridge to be stored in the rotary 9 (step S208). Upon completion of storing of the toner cartridge, the CPU 110 opens the toner supply valve 200 by driving the toner supply valve opening/closing unit 201 with use of the toner supply valve control unit 112 in step S209.

On the other hand, if it is determined that the changed signal levels are not LH in step S213, it can be determined that the post-exchange toner cartridge 7 is a toner cartridge that is different in color from the magenta toner cartridge 7b. Therefore, in step S206, the CPU 110 outputs a message indicating that the toner cartridge is wrong, or ejects the tray 8 to which the toner cartridge to be exchanged is attached if a necessary mechanism is provided.

If it is determined that the exchange target is not the magenta toner cartridge in step S210, the CPU 110 determines whether the exchange target is the cyan toner cartridge (step S214). In a case where the exchange target is the cyan toner cartridge, the CPU 110 executes processing similar to steps S211 to S213 in steps S215 to S217. Note that as the color of the exchange target is cyan, processing executed here is different from steps S211 to S213 in that the tray moved in step S215 and the signal levels of the I/O ports determined in step S217 correspond to cyan, that is to say, they are the tray 8c and the signal levels HL. If the exchange target is not any of the above, the exchange target is the black toner cartridge, and thus the CPU 110 executes processing similar to steps S211 to S213 in steps S219 to S221. Note that as the color of the exchange target is black, processing executed here is different from steps S211 to S213 in that the tray moved in step S219 and the signal levels of the I/O ports determined in step S221 correspond to black, that is to say, they are the tray 8d and the signal levels LL.

As described above, according to the present embodiment, toner cartridges are provided with conductive members that are combined differently among the color components corresponding to the toner cartridges, and the detection unit of the image forming apparatus detects the states of conduction (conducted or insulated) with use of a current flowing through these conductive members in response to the exchange operation. In this way, a color component corresponding to a toner cartridge can be specified based on a state where a toner cartridge has been exchanged, and on the detected combination of states of conduction of the conductive members.

The aforementioned configuration and operation make it possible to determine whether a post-exchange toner cartridge is a toner cartridge of a color that is an exchange target. Therefore, in the present embodiment, the same toner cartridge, or developer container, can be used for each color. Although the black toner cartridge is a different container as its capacity is large in the present embodiment, it may be the same as cartridges of other colors.

### Third Embodiment

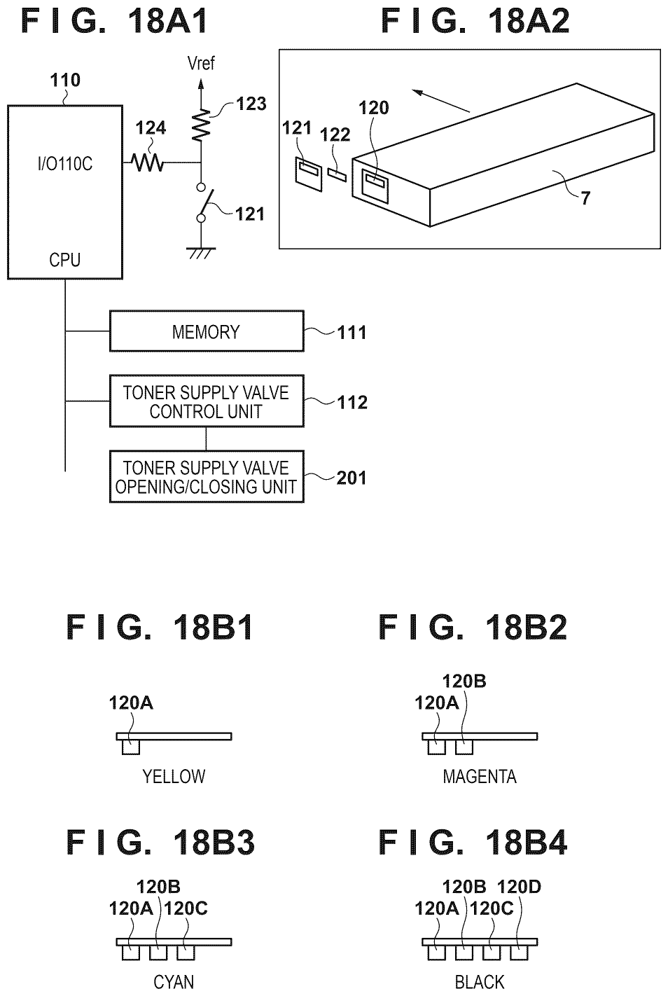

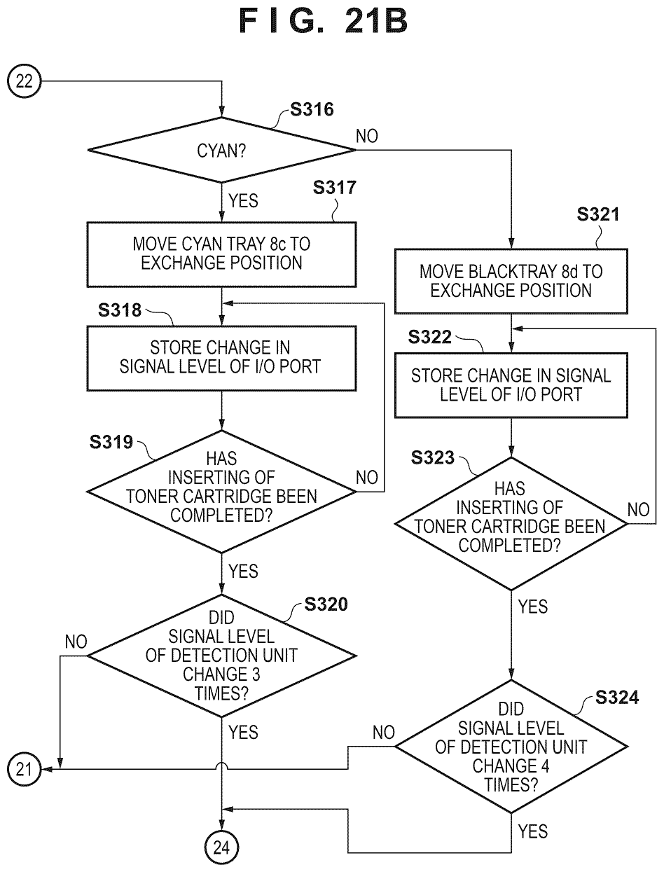

Using FIG. 18A1 to FIG. 21, a method of distinguishing a toner cartridge according to the present embodiment will be described. In the second embodiment, the contacts of the toner cartridges 7 have different states (open-circuited, short-circuited) to distinguish a toner cartridge, and the distinction is made by detecting these states. In contrast, in the present embodiment, a toner cartridge 7 is provided with a protrusion(s) for distinguishing the toner cartridge, the image forming apparatus 1 is provided with a switch, and which toner cartridge 7 has been inserted is distinguished by detecting the state of the protrusion(s) with use of the switch.

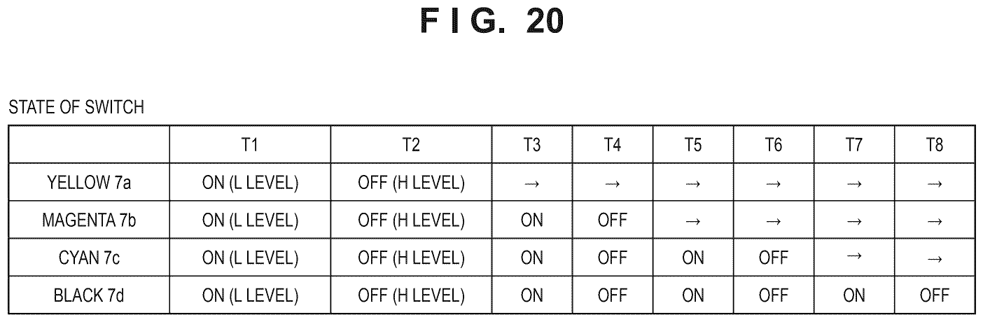

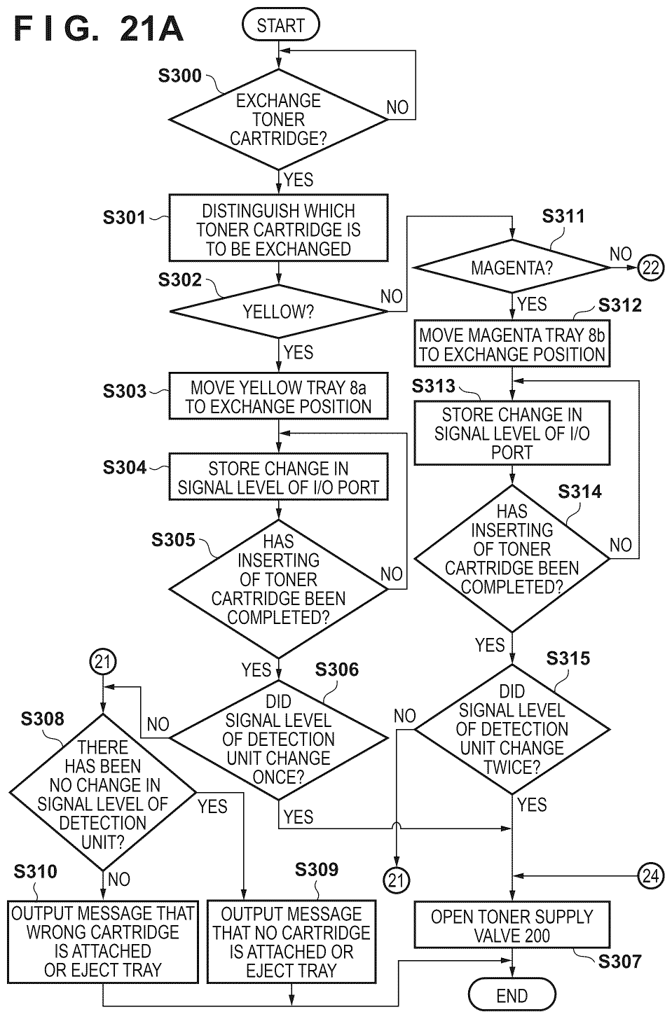

FIG. 18A1 to FIG. 20 show a configuration of a distinction unit included in a toner cartridge, and a configuration of a detection unit inside the image forming apparatus 1 for distinguishing a toner cartridge.

As shown in FIG. 18A2, a toner cartridge 7 is configured to include a protrusion unit 120 including protrusions 120A to 120D, which will be described later, and the number of protrusions varies with each of the colors of the toner cartridges 7. The protrusions in the protrusion unit 120 are configured to press a switch 121 via a leaf spring 122 provided in the image forming apparatus 1 by coming into contact with the leaf spring 122, thereby switching the switch 121 from OFF to ON. This design makes it possible to distinguish the color of the toner cartridge 7 on the basis of the number of protrusions in the toner cartridge 7. Therefore, the protrusion units 120A to 120D are arranged at an interval that leaves the switch 121 OFF in a state where the leaf spring 122 is located in a gap between the protrusion units.

For example, the yellow toner cartridge 7a is provided with one protrusion 120A as shown in FIG. 18B1, and the magenta toner cartridge 7b is provided with two protrusions 120A and 120B as shown in FIG. 18B2. Also, the cyan toner cartridge 7c is provided with three protrusions 120A, 120B, and 120C as shown in FIG. 18B3, and the black toner cartridge 7d is provided with four protrusions 120A, 120B, 120C, and 120D as shown in FIG. 18B4.

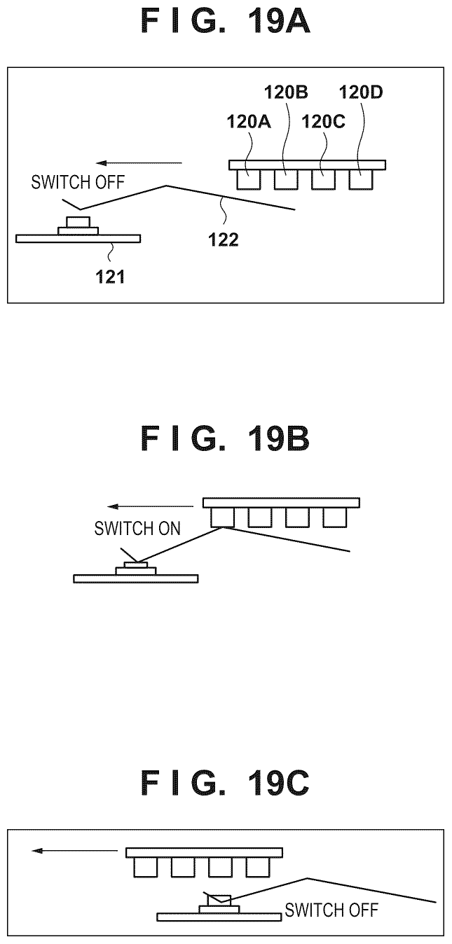

This state is shown in FIG. 19A to FIG. 19C. FIG. 19A shows a state before the protrusion unit 120 comes into contact with the leaf spring 122. FIG. 19B shows a state where the protrusion unit 120 is in contact with the leaf spring 122. FIG. 19C shows a state where, after the protrusion unit 120 has come into contact with the leaf spring 122, the cartridge 7 is further inserted to the back of the rotary 9. In FIG. 19A and FIG. 19C, the switch 121 is OFF because it is not pressed. On the other hand, the switch 121 is configured to be ON by getting pressed via the leaf spring 122 when the protrusion unit 120 is in contact with the leaf spring 122 as shown in FIG. 19B.

Note that, similarly to the first embodiment, these switch 121 and leaf spring 122 are positioned so that, midway between insertion of the toner cartridge 7 and closure of the door 14 upon completion of the insertion, they reach from the state of FIG. 19A to the state of FIG. 19C via the state of FIG. 19B. Note that although the leaf spring is used in the present embodiment, other methods may be used as means for pressing the switch. Furthermore, as shown in FIG. 18A1, one side of the switch 121 is connected to GND, and the other side of the switch 121 is connected, via a resistor 123 and a series resistor 124, to an I/O port 110C of the CPU 110 responsible for control on the image forming apparatus 1. The other side of the resistor 123 is connected to a power source Vref. With this configuration, in the present example, a signal input to the I/O ports 110C has the signal level of an input to or an output from the CPU 110 (the high level H or the low level L).

FIG. 20 shows the state of the switch for each of the colors of the toner cartridges 7. In this figure, the leftmost column indicates the names of toner cartridges 7 of respective colors, namely the yellow toner cartridge 7a, the magenta toner cartridge 7b, the cyan toner cartridge 7c, and the black toner cartridge 7d. Columns on the right of this column indicate the flow of time from attachment of a toner cartridge 7 to a tray to insertion of the toner cartridge 7. Time flows in a rightward direction, namely in the order of T1→T2→T3→ . . . →T8.

The input signal to the I/O port 110C varies depending on whether the toner cartridge 7 includes the protrusions 120A to 120D. The input signal changes between the H level, which is caused when the switch 121 is OFF due to absence of the protrusions, and the L level, which is caused when the switch 121 is ON due to presence of the protrusions. Which toner cartridge 7 has been inserted can be distinguished depending on the number of times the switch 121 changes to the L level until the completion of insertion of the toner cartridge 7.

Next, a flow of determining whether a toner cartridge is a predetermined toner cartridge will be described using a flowchart of FIG. 21A and FIG. 21B. A procedure of FIG. 21A and FIG. 21B is also realized by the CPU 110 executing a program stored in the memory 111.

First, whether a toner cartridge is to be exchanged is determined (step S300), and in a case where the exchange is to be performed, which toner cartridge is to be exchanged is distinguished (step S301). It is sufficient for these determination and distinction to be based on an instruction issued by a user from the operation unit. For example, when an instruction for exchanging the black toner cartridge has been issued from the operation unit, it can be distinguished that a toner cartridge is to be exchanged, and further that the exchange target is the black toner cartridge 7d.

First, the CPU 110 determines whether the toner cartridge to be exchanged based on the instruction is the yellow toner cartridge 7a (step S302). If the exchange target is the yellow toner cartridge 7a, the CPU 110 causes the yellow tray 8a to move to the exchange position (also referred to as a cartridge exchange opening 14) by rotating the rotary 9 (step S303). If the image forming apparatus 1 has a function of moving a tray 8 located at the exchange position between a state where it is stored in the rotary 9 and a state where it is exposed through the door 14 (referred to as a tray moving function), the tray 8a may be moved to the outside of the door 14 in step S303. Otherwise, a worker may manually pull out the tray 8a through the door 14.

In this state, the worker detaches the toner cartridge 7a from the tray 8a and exchanges the same to a new toner cartridge. If the image forming apparatus has the tray moving function, for example, when the worker has performed an operation indicating that the exchange has been done after the exchange, the CPU 110 accordingly causes the tray 8a to move to the inside of the rotary 9. On the other hand, if there is no tray moving function, the worker manually pushes the tray 8a into the inside of the rotary 9.

After step S303, the CPU 110 stores a change in the signal level of the I/O port 110C into the memory 111 or the like (step S304). Then, the CPU 110 stands by until completion of storing of the toner cartridge 7 attached to the tray 8a into the rotary 9 (step S305). It is sufficient that this determination be made based on, for example, a signal detected by the tray storage detection sensor 99. In the present embodiment, unlike the second embodiment, a state where the toner cartridge 7 is not attached to the tray 8 can be detected based on a change in the signal level of the I/O port 110C. Therefore, it is sufficient that the tray storage detection sensor 99 of the present embodiment be capable of detecting storing of the tray 8, and it need not additionally detect the attachment of the toner cartridge 7 thereto. Furthermore, during the standby loop of steps S304 and S305, the CPU 110 obtains a signal of the I/O port 110C and continuously stores a change in the signal level thereof.

In a case where it is determined that storing of the toner cartridge 7 has been completed in step S305, the CPU 110 determines whether the count of stored changes in the signal level of the detection unit is one (step S306). This count of changes in the signal level is the count of changes in the signal level from the H level, which is a reference, to the L level. The signal level of the detection unit, namely the I/O port 110C is the H level in a state where the tray 8 is outside the door 14; as the yellow toner cartridge 7a includes one protrusion, the signal level changes as follows: H→L→H. Out of these changes, the count of changes from H→L is determined in step S306. Note that when a change of L→H is also included in the count, it is sufficient to determine whether the count of changes is the number that is twice as much as one, that is to say, two, instead of determining whether the count of changes is one.

In a case where it is determined that the count of changes in the signal level is one in step S306, the CPU 110 opens the toner supply valve 200 by controlling the toner supply valve control unit 112 (step S307).

On the other hand, in a case where it is determined that the count of changes in the signal level is not one in step S306, the CPU 110 determines whether there has been no change in the signal level of the detection unit (step S308). In a case where it is determined that the signal level has not changed, it means that no toner cartridge 7 is attached to the tray 8. Therefore, the CPU 110 outputs a message or the like indicating that no toner cartridge 7 is attached, or causes the unloaded tray 8 to be moved out of the rotary 9 and ejected to the outside of the apparatus (step S309). On the other hand, in a case where it is determined that the signal level has changed, it can be determined that a toner cartridge 7 that is not the exchange target has been attached to the tray 8. Therefore, the CPU 110 outputs a message indicating that a toner cartridge 7 that is not the exchange target has been attached, or causes the tray 8 with the post-exchange toner cartridge 7 to be moved out of the rotary 9 and ejected to the outside of the apparatus (step S310).

In a case where it is determined that the toner cartridge to be exchanged is not the yellow toner cartridge in step S302, whether the toner cartridge to be exchanged is the magenta toner cartridge is determined (step S311). If the exchange target is not the magenta toner cartridge 7b, the CPU 110 determines whether the toner cartridge to be exchanged is the cyan toner cartridge (step S316). If the toner cartridge to be exchanged is not the cyan toner cartridge, it can be determined that the toner cartridge to be exchanged is the black toner cartridge.

In a case where it is determined that the toner cartridge to be exchanged is the magenta toner cartridge in step S311, the CPU 110 executes steps S312 to S315, which are processing equivalent to steps S303 to S306. Steps S312 to S315 differ from steps S303 to S306 in that the target which is moved in step S312 and for which the completion of insertion is determined in step S314 is the magenta tray 8b, and in that the count of changes in the signal level of the detection unit determined in step S315 is two.

Also, in a case where it is determined that the toner cartridge to be exchanged is the cyan toner cartridge in step S316, the CPU 110 executes steps S317 to S320, which are processing equivalent to steps S303 to S306. Steps S317 to S320 differ from steps S303 to S306 in that the target which is moved in step S317 and for which the completion of insertion is determined in step S319 is the cyan tray 8c, and in that the count of changes in the signal level of the detection unit determined in step S320 is three.

Also, in a case where it is determined that the toner cartridge to be exchanged is not the cyan toner cartridge in step S316, the CPU 110 executes steps S321 to S324, which are processing equivalent to steps S303 to S306. Steps S321 to S324 differ from steps S303 to S306 in that the target which is moved in step S321 and for which the completion of insertion is determined in step S323 is the black tray 8d, and in that the count of changes in the signal level of the detection unit determined in step S324 is four.

As described above, in the present embodiment, toner cartridges of different color components include different numbers of protrusions. Then, in response to a toner cartridge exchange operation, the detection unit of the image forming apparatus 1 detects the color component of the corresponding toner cartridge by specifying the number of protrusions thereof. This makes is possible to detect (or specify) a state where a toner cartridge has been exchanged, and the color of the post-exchange toner cartridge.

The aforementioned configuration and operation make it possible to determine whether a post-exchange toner cartridge is a toner cartridge of a color that is an exchange target. Therefore, in the present embodiment, the same toner cartridge, or developer container, can be used for each color. Although the black toner cartridge is a different container as its capacity is large in the present embodiment, it may be the same as cartridges of other colors.

As described above using the three embodiments, toner cartridges are provided with characteristic portions intended for color-by-color identification, and the image forming apparatus body is provided with a detection unit that detects these characteristic portions, without changing the shapes of the toner cartridges on a color-by-color basis. In this way, a toner cartridge of each color is identified. Especially, in any of the embodiments, by taking advantage of a movement of a toner cartridge 7 when it is stored into the rotary 9, a characteristic signal corresponding to each color is generated based on this movement through coordinated operations of a circuit provided in the toner cartridge and the detection unit of the image forming apparatus, and this characteristic signal is detected. This makes it possible to determine whether the post-exchange toner cartridge is the expected toner cartridge.

Furthermore, a resistor included in a toner cartridge may be replaced with a coil or a capacitor. In this case, an alternating-current signal may be used as a detection signal. This makes it possible to detect a type (color component) of a toner cartridge in accordance with the impedance of the circuit of the toner cartridge.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-062299, filed Apr. 8, 2024 which is hereby incorporated by reference herein in its entirety.

What is claimed is:

1. An image forming apparatus to/from which a first cartridge and a second cartridge are attachable/detachable, the first cartridge storing a first developer, and the second cartridge storing a second developer, the image forming apparatus comprising:
a rotary including a first developing chamber configured to store the first developer supplied from the first cartridge, and a second developing chamber configured to store the second developer supplied from the second cartridge;
a first tray by which the first cartridge is attachably/detachably supported, and which is displaced, relative to the rotary, between a first position where the first cartridge is located outside the rotary and a second position where the first cartridge is located inside the rotary;
a second tray by which the second cartridge is attachably/detachably supported, and which is displaced, relative to the rotary, between a third position where the second cartridge is located outside the rotary and a fourth position where the first cartridge is located inside the rotary; and
a detector connected to a circuit including a third contact portion,
wherein
after the first cartridge supported by the first tray has started to move from the first position to the second position, a first contact portion included in the first cartridge comes into contact with the third contact portion,
in a case where the first contact portion has come into contact with the third contact portion, a first current is generated in the circuit, and the detector detects a signal that is based on the first current,
after the second cartridge supported by the first tray has started to move from the first position to the second position, a second contact portion included in the second cartridge comes into contact with the third contact portion, and
in a case where the second contact portion has come into contact with the third contact portion, a second current is generated in the circuit, and the detector detects a signal that is based on the second current.

2. The image forming apparatus according to claim 1, wherein
the first cartridge includes a first circuit including the first contact portion, the second cartridge includes a second circuit including the second contact portion, the first contact portion and the second contact portion are electrically connectable to the contacted potion, and the first circuit and the second circuit have different resistor values from each other, and
the first current is a current corresponding to the resistor value of the first circuit, and the second current is a current corresponding to the resistor value of the second circuit.

3. The image forming apparatus according to claim 2, wherein
the first contact portion includes two electrodes, the first circuit includes a first resistor with terminals that are respectively connected to the two electrodes, the second contact portion includes two electrodes, and the second circuit includes a second resistor with terminals that are respectively connected to the two electrodes, the second resistor having a resistor value different from a resistor value of the first resistor.

4. The image forming apparatus according to claim 3, wherein
the detector detects completion of storing of the first tray or the second tray into the rotary upon detection of separation of the third contact portion from the first contact portion of the first cartridge or the second contact portion of the second cartridge after the third contact portion has come into contact with the first contact portion or the second contact portion in response to a movement for storing the first tray.

5. The image forming apparatus according to claim 1, wherein
the first contact portion and the second contact portion include conductive members that are combined differently therebetween, and
the detector detects that a cartridge corresponds to the first tray by specifying a combination of the conductive members in response to a movement for storing the first tray.

6. The image forming apparatus according to claim 5, wherein
the first cartridge and the second cartridge are provided with at least two pairs of electrodes, and a combination of the conductive members is composed of whether there is electrical connection between the electrodes in each pair, and
the detector detects that a cartridge attached to the first tray is the first cartridge by specifying a combination of the conductive members via the third contact portion that comes into contact with each of the at least two pairs of electrodes.

7. The image forming apparatus according to claim 1, wherein
the first contact portion and the second contact portion include different numbers of protrusions, and
the detector detects that a cartridge attached to the first tray is the first cartridge by specifying the number of the protrusions in response to a movement for storing the first tray.

8. The image forming apparatus according to claim 7, wherein
the protrusions are arranged along a direction of the movement for storing the first tray, and
the detector detects that a cartridge attached to the first tray is the first cartridge by specifying the number of the protrusions via a switch that is turned ON by the protrusions.

9. The image forming apparatus according to claim 1, further comprising:
a valve opening mechanism that opens an openable/closable valve for supplying a developer stored in a cartridge attached to the first tray to the first developing chamber;
at least one memory storing instructions; and
at least one processor that is in communication with the at least one memory and that, when executing the instructions, cooperates with the at least one memory to execute processing, the processing including
opening the valve with use of the valve opening mechanism in a case where the detector has detected that the cartridge attached to the first tray is the first cartridge.

10. The image forming apparatus according to claim 9, further comprising:
a second detector that detects that the first cartridge or the second cartridge has been stored into the rotary,
wherein the processing includes opening the valve with use of the valve opening mechanism in a case where the detector has detected that the cartridge attached to the first tray is the first cartridge and the first cartridge has been stored into the rotary.
